(19) United States
(12) Patent Application Publication
(10) Pub. No.: US 2025/0079713 A1
(43) Pub. Date: Mar. 6, 2025

(54) ANTENNA MODULE AND COMMUNICATION DEVICE

(71) Applicant: HUAWEI TECHNOLOGIES CO., LTD., Shenzhen (CN)

(72) Inventors: Haibing XU, Shanghai (CN); Meiqing QI, Shanghai (CN); Xiao ZHOU, Shanghai (CN); Wei WU, Shanghai (CN); Zui TAO, Nanjing (CN); Jie ZHAO, Nanjing (CN)

(21) Appl. No.: 18/950,942

(22) Filed: Nov. 18, 2024

Related U.S. Application Data
(63) Continuation of application No. PCT/CN2023/079659, filed on Mar. 3, 2023.

(30) Foreign Application Priority Data
May 20, 2022 (CN) 202210562036.3

(51) Int. Cl. H01Q 9/04; H01Q 1/48

(52) U.S. Cl. CPC H01Q 9/045; H01Q 1/48

(57) ABSTRACT

This application provides an antenna module and a communication device. The antenna module includes a radiating element, a ground element, and a feed element. The feed element is a transmission line structure formed on an insulation support. The feed element includes a feed transmission part and a ground part. The feed transmission part and the ground part are not equal in width, and are configured to implement current balance of the antenna module.

### CROSS-REFERENCE TO RELATED APPLICATIONS

This application is a continuation of International Application No. PCT/CN2023/079659, filed on Mar. 3, 2023, which claims priority to Chinese Patent Application No. 202210562036.3, filed on May 20, 2022. The disclosures of the aforementioned applications are hereby incorporated by reference in their entireties.

### TECHNICAL FIELD

The present invention relates to the field of network communication technologies, and in particular, to an antenna module and a communication device.

### BACKGROUND

In a MIMO system, namely, a multiple-input multiple-output system, a plurality of transmit and receive antennas are disposed, and specific data processing is performed, to multiply a communication capacity, thereby meeting increasing communication service requirements. In a communication device, a plurality of antenna elements need to be connected to a radio frequency chip on a mainboard through a feeder cable. The feeder cable is configured to feed power to the antenna elements. The feeder cable not only makes an internal space of the communication device messy, but also requires high process precision for assembling and fastening the feeder cable. As a result, it is difficult to reduce costs of the communication device.

Therefore, how to implement a cable-free design on a premise of ensuring antenna radiation performance to make an internal structure of the communication device simple and reduce assembly costs of an antenna module is a direction continuously explored in the industry.

### SUMMARY

This application provides an antenna module and a communication device, to implement a cable-free design on a premise of ensuring radiation performance of an antenna, so that an internal structure of the communication device is simple, and costs are low.

According to a first aspect, this application provides an antenna module, including: a radiating element, a ground element, and a feed element, where the radiating element and the ground element are stacked; and a feed element, which is a transmission line structure formed on an insulation support. In a first direction, the feed element is located on a side that is of the ground element and that is away from the radiating element. The feed element includes a feed transmission part and a ground part. The feed transmission part is separated and insulated from the ground part. A width of the feed transmission part includes a first width, and a width of the ground part includes a second width. The first width is not equal to the second width. The width of the feed transmission part is a dimension of the feed transmission part in a direction perpendicular to an extension path of the feed transmission part, and the width of the ground part is a dimension of the ground part in a direction perpendicular to an extension path of the ground part.

In this application, the feed element of the transmission line structure disposed on the insulation support feeds power to the radiating element, and widths of the ground part and the feed transmission part are unequal. This can implement current balance of the antenna module. An unequal width design of the feed transmission part and the ground part of the feed element has a decoupling effect. In other words, this can eliminate or reduce a coupling effect on the radiating element generated by the feed element, thereby improving radiation performance of the antenna module. Specifically, the radiating element and the ground element in the antenna module provided in this application form an asymmetric architecture. The asymmetric architecture means that the radiating element and the ground element are different structures. In a resonant state, the radiating element and the ground element generate current imbalance. Specifically, a current on the radiating element and a current on the ground element have unequal amplitudes, and the directions of the currents are also different. In this application, the unequal width design of the feed transmission part and the ground part is used, to resolve a problem of impedance mismatch caused by current imbalance generated by the radiating element and the ground element. The unequal width design of the feed transmission part and the ground part achieves a current balance effect on the entire antenna module.

In a possible implementation, on the extension path of the feed transmission part, an electrical length of the feed transmission part is between 0.3λ and 0.7λ, and λ is a wavelength of an electromagnetic wave of the radiating element in the resonant state. Specifically, the electrical length of the feed transmission part may be 0.5λ. In this solution, a specific range (between 0.3λ and 0.7λ) and a specific value (0.5λ) of the electrical length of the feed transmission part are limited, so that the feed transmission part has a balun function, to ensure repetition continuity of impedance matching in the antenna module. The repetition continuity of impedance matching may be understood as that impedance matched at two ends of the feed transmission part is the same. In this way, another matching circuit does not need to be disposed on the feed transmission part to adjust matched impedance.

In a possible implementation, the extension path of the feed transmission part and the extension path of the ground part form an architecture of double parallel lines. This may be understood as follows: A gap between a first feed end of the feed transmission part and a first ground end of the ground part is the same as a gap between a second feed end of the feed transmission part and the first ground end of the ground part. In addition, on an extension path of the first feed end and the ground part, a gap between the first feed end and the ground part remains unchanged. The feed element is designed as an architecture of double parallel lines, so that the feed element can form equal-amplitude reverse currents when the antenna module is in a working state, to prevent the feed element from affecting resonance of the radiating element. This ensures that the antenna module is a vertically polarized antenna, and a good radiation pattern can be obtained.

In a possible implementation, a total electrical length of the feed transmission part in a second direction is between 0.15λ and 0.35λ, λ is the wavelength of the electromagnetic wave of the radiating element in the resonant state, and the second direction is perpendicular to the first direction. In a specific implementation, the total electrical length of the feed transmission part in the second direction is 0.25λ. The electrical length of the feed transmission part in the second direction is limited, so that an induced current can be curbed. This can implement decoupling between the feed element and the radiating element, and reduce coupling between the feed element and the radiating element, thereby improving radiation efficiency of the radiating element.

In a possible implementation, some transmission lines that are of the feed transmission part and that extend in the second direction are collinear. This solution is a simple cabling solution for the feed transmission part. The electrical length of the feed transmission part is easily controlled, and an effect of curbing an induced current is more obvious.

In a possible implementation, some transmission lines that are of the feed transmission part and that extend in the second direction include at least two transmission line segments, and the at least two transmission line segments are connected to each other through a transmission line that extends in the first direction. The at least two transmission line segments may be parallel to each other. This solution is a specific cabling solution for the feed transmission part. In this application, feed transmission parts in different forms may be disposed based on different specific assembly environments and electromagnetic field environments of the antenna module, and a specific transmission form on an insulation setting may be adjusted to implement different designs. This is simple and easy to implement.

In a possible implementation, the feed transmission part and the ground part are coplanar. In other words, the feed transmission part and the ground part are on a same plane, that is, planes of the insulation support bearing the feed transmission part and the ground part are the same. For example, when the insulation support is a circuit board structure, the feed transmission part and the ground part are located at a same layer of the circuit board. Thicknesses of the feed transmission part and the ground part are not considered in this application. The thicknesses of the feed transmission part and the ground part may be different. However, it may be understood that the feed transmission part and the ground part are coplanar, provided that the feed transmission part and the ground part are disposed on a same plane. Manufacturing costs of the coplanar design are low, and a position relationship between the feed transmission part and the ground part is easy to control.

In a possible implementation, a plane on which the feed transmission part is located and a plane on which the ground part is located are not coplanar. The feed transmission part and the ground part are disposed opposite to each other (which may be a relationship of being directly opposite to each other) in a third direction. The third direction is perpendicular to the second direction, and the third direction is also perpendicular to the first direction. In this solution, the feed transmission part and the ground part form a non-coplanar transmission line architecture. For example, the feed transmission part and the ground part may be located at different layers of a circuit board. Compared with that in a coplanar design, the non-coplanar transmission architecture provided in this solution has advantages of saving a space and reducing an area occupied on the board. A thickness of a substrate of the circuit board is just used for insulation between the feed transmission part and the ground part, thereby reducing manufacturing costs.

In a possible implementation, in the resonant state, a current on the feed transmission part and a current on the ground part have equal amplitudes, but directions of the currents are reverse.

In a possible implementation, the feed transmission part includes a first feed end and a second feed end, the first feed end is electrically connected to the radiating element, and the second feed end is configured to electrically connect to a radio frequency chip on a mainboard of a communication device; and from the first feed end to the second feed end, the feed transmission part extends in equal widths; and/or
the ground part includes a first ground end and a second ground end, the first ground end is electrically connected to the ground element, the second ground end is configured to electrically connect to a ground on the mainboard of the communication device, and from the first ground end to the second ground end, the ground part extends in equal widths.

In a possible implementation, the feed transmission part includes a first feed end and a second feed end, the first feed end is electrically connected to the radiating element, the second feed end is configured to electrically connect to a radio frequency chip on a mainboard of a communication device, and from the first feed end to the second feed end, a part of the feed transmission part extends in equal widths, and a part of the feed transmission part extends in unequal widths; and/or
the ground part includes a first ground end and a second ground end, the first ground end is electrically connected to the ground element, the second ground end is configured to electrically connect to a ground on the mainboard of the communication device, and from the first ground end to the second ground end, a part of the ground part extends in equal widths, and a part of the ground part extends in unequal widths.

In a possible implementation, the feed transmission part includes a first feed end and a second feed end, the first feed end is electrically connected to the radiating element, the second feed end is configured to electrically connect to a radio frequency chip on a mainboard of a communication device, and from the first feed end to the first feed end, the feed transmission part extends in equal widths; and
the ground part includes a first ground end and a second ground end, the first ground end is electrically connected to the ground element, the second ground end is configured to electrically connect to a ground on the mainboard of the communication device, and from the first ground end to the second ground end, a part of the ground part extends in equal widths, and a part of the ground part extends in unequal widths.

In a possible implementation, the ground part includes a first ground end and a second ground end, the first ground end is electrically connected to the ground element, the second ground end is configured to electrically connect to a ground on a mainboard of a communication device, and from the first ground end to the second ground end, the ground part extends in equal widths; and
the feed transmission part includes a first feed end and a second feed end, the first feed end is electrically connected to the radiating element, the second feed end is configured to electrically connect to a radio frequency chip on the mainboard of the communication device, and from the first feed end to the first feed end, a part of the feed transmission part extends in equal widths, and a part of the feed transmission part extends in unequal widths.

This application provides several combination solutions of the feed transmission part and the ground part. The equal width design of the feed transmission part and the ground part may be combined with the unequal width design of the feed transmission part and the ground part. In a specific implementation, the unequal width design of the feed transmission part may be a design in which widths change gradually. This helps adjust impedance.

In a possible implementation, the antenna module includes a first plate and a second plate. The first plate includes a first layer and a second layer that are stacked. The radiating element is located at the first layer, and the ground element is located at the second layer. The second plate is the insulation support. The second plate includes a first edge and a second edge that are disposed opposite to each other and a cabling layer. The cabling layer is located between the first edge and the second edge. The second plate is located on a side of the first plate. The first edge is connected to the first plate. The feed element is disposed at the cabling layer. An included angle is formed between the cabling layer and the first layer.

In this solution, the antenna module is provided with the first plate and the second plate. A manufacturing process is simple, and manufacturing costs are low. In addition, the antenna module has an advantage of a light weight. This facilitates a design of a slim and short communication device. The first plate and the second plate may be a printed circuit board architecture. The feed element and the radiating element of the antenna module are a transmission line architecture disposed on the printed circuit board. The antenna module does not include any feeder cable, and the communication device does not have a feeder cable, so that an internal structure of the communication device is simple. In addition, a position and a form of the transmission line are fixed, and are designed before the antenna module is assembled. Therefore, there is no adverse impact on the antenna caused in an assembly process. In addition, a low-loss board-level interconnection may be implemented between the first plate and the second plate. In this way, assembly costs are low, and for the antenna module, a loss generated by the connection between the first plate and the second plate is low.

In a possible implementation, the ground part is electrically connected to the ground element through the connection between the first edge and the first plate. A connection structure is disposed at a joint between the first plate and the second plate. The connection structure is configured to implement an electrical connection between the feed transmission part and the radiating element. In this application, in a process of assembling and connecting the first plate and the second plate, the electrical connection between the feed element and the radiating element and the electrical connection between the feed element and the ground element can be implemented. Such electrical connections are reliable, and a loss is low.

In a possible implementation, the first plate is provided with a hole that penetrates the first layer and the second layer. The second plate includes a plug structure protruding from the first edge. At least a part of the plug structure is located in the hole. The connection structure includes the hole and the plug structure. The connection structure further includes a conductive connecting part. The conductive connecting part is electrically connected between the radiating element and the feed transmission part. This solution provides a specific design of the connection structure. The plug structure matches the hole, to implement easy assembly and easy electrical connection.

In a possible implementation, the hole is a through hole. The hole includes a first open end and a second open end. The plug structure is plugged into the hole from the first open end. The conductive connecting part is welded onto the radiating element from a side of the second open end. The feed transmission part and the radiating element are electrically connected on the side of the second open end through welding, and there is a sufficient operation space for operation work. This reduces the assembly costs of the antenna module and ensures a welding yield.

In a possible implementation, the first layer is a top surface of the first plate, and the second layer is a bottom surface of the first plate. The first open end is located on the bottom surface, and the second open end is located on the top surface. In this solution, the radiating element is disposed on the top surface of the first plate, and the ground element is disposed on the bottom surface of the first plate, so that the antenna module has a smaller volume and the communication device is thinner.

In a possible implementation, the second edge of the second plate is connected to the mainboard of the communication device. The ground part of the feed element is electrically connected to a grounding plane on the mainboard. The feed transmission part is electrically connected to the radio frequency chip on the mainboard through a transmission line disposed on the mainboard. In this solution, a connection relationship between a position of the second edge of the second plate and the mainboard is limited. No external cable is required, and only a circuit board cable (the transmission line structure) in the mainboard is required to implement grounding of the ground part and the electrical connection between the feed transmission part and the radio frequency chip.

In a possible implementation, a first primary antenna is disposed on the second plate. The radiating element, the ground element, and the feed element form a second primary antenna. A resonance frequency of the first primary antenna is a first frequency. A resonance frequency of the second primary antenna is a second frequency. The second frequency is higher than the first frequency.

In a possible implementation, the first frequency is 2.4 GHz, and the second frequency is 5 GHz.

In a possible implementation, the antenna module includes a plurality of antenna elements. Each antenna element includes one first primary antenna and one second primary antenna. The antenna element further includes a first decoupling structure and a second decoupling structure. The first decoupling structure is located on the second plate. The antenna module further includes a third plate. The third plate and the second plate are disposed in an intersecting manner, and the second decoupling structure is located on the third plate. In this application, a distance between two first primary antennas is shortened, and the first primary antenna and the second primary antenna are disposed on a same support, to save a space of the mainboard and facilitate a small-dimension design of the antenna module. The first decoupling structure and the second decoupling structure are disposed to ensure isolation, thereby improving efficiency of radiation between the two first primary antennas.

In this application, the distance between the two first primary antennas is set between 0.2 times the wavelength and 0.8 times the wavelength, and isolation between the two first primary antennas is improved in combination with the first decoupling structure and the second decoupling structure. The distance between the two first primary antennas is between 0.2 times the wavelength and 0.8 times the wavelength. If the first decoupling structure is not disposed in each antenna element, when the two first primary antennas are in the resonant state, the two first primary antennas receive signals from each other, resulting in signal interference and poor isolation.

In a possible implementation, ends that are of the second plate and the third board and that are away from the first plate are connected to the mainboard of the communication device. In a direction perpendicular to the grounding plane on the mainboard of the communication device, a longest distance between the first decoupling structure and the grounding plane is a section height of the first decoupling structure. The section height of the first decoupling structure is between 0.01 times the wavelength and 0.16 times the wavelength. A distance between the first decoupling structure and the first primary antenna is a first distance. A distance between the first decoupling structure and a first primary antenna of an adjacent antenna element is a second distance. Both the first distance and the second distance are between 0.1 times the wavelength and 0.6 times the wavelength. The second decoupling structure is configured to reduce an amount of coupling between the first primary antenna and the first primary antenna of the adjacent antenna element. The resonance frequency of the second decoupling structure is higher than the first frequency or lower than the first frequency.

In this application, the first decoupling structure is disposed to implement a small dimension of the antenna. This facilitates a thin design of the communication device, and can further resolve a problem of isolation between adjacent first primary antennas. The section height of the first decoupling structure, the distance between the first decoupling structure and the first primary antenna, and the distance between the first decoupling structure and the adjacent first primary antenna are controlled, to improve isolation between the adjacent first primary antennas in a limited space and reduce impact on radiation efficiency of the first primary antennas. Consequently, there is no obvious dent in a simulation diagram of the radiation efficiency of the first primary antennas.

In this application, the resonance frequency of the second decoupling structure is adjusted, so that the resonance frequency of the second decoupling structure is not the same as the first frequency, but is slightly higher or lower. This implements decoupling between the first primary antennas, thereby improving isolation and reducing the impact on the radiation efficiency of the antenna. Specifically, when the second decoupling structure generates resonance, an efficiency dent is generated for an electromagnetic wave at a resonance frequency of the second decoupling structure. For the first primary antenna, the efficiency dent generated by the second decoupling structure may avoid an in-band frequency (namely, the first frequency) of resonance of the first primary antenna, to reduce impact of the second decoupling structure on the radiation efficiency of the first primary antenna.

In a possible implementation, the radiating element, the ground element, and the feed element form a vertically polarized antenna that is disposed horizontally.

According to a second aspect, this application provides a communication device, including a radio frequency chip and the antenna module according to any one of the possible implementations of the first aspect. The radio frequency chip is configured to process electromagnetic wave signals received and sent by the antenna module.

### BRIEF DESCRIPTION OF DRAWINGS

To describe the technical solutions in embodiments of the present invention or in the background more clearly, the following describes the accompanying drawings for describing embodiments of the present invention or the background.

FIG. 1 is an assembly diagram of a communication device in a direction according to an implementation of this application;

FIG. 2 is an assembly diagram of a communication device in another direction according to an implementation of this application;

FIG. 3 is a three-dimensional exploded diagram of a communication device according to an implementation of this application;

FIG. 4 is a cross-sectional diagram of a communication device according to an implementation of this application;

FIG. 5 is a diagram of an inner side of a second housing of a communication device according to an implementation of this application;

FIG. 6 is a diagram of distribution of at least some electronic components on a bottom surface of a mainboard of a communication device according to an implementation of this application;

FIG. 7 is a three-dimensional exploded diagram of an antenna module according to an implementation of this application;

FIG. 8 is a three-dimensional exploded diagram of an antenna module in another direction according to an implementation of this application;

FIG. 9 is a cross-sectional diagram of an antenna module according to an implementation of this application;

FIG. 9A, FIG. 9B, and FIG. 9C each show a position relationship between a radiating element and a ground element of an antenna module according to a specific implementation of this application;

FIG. 10 is a diagram of feeding power to an antenna module through a feeder cable in the conventional technology;

FIG. 11 is a diagram of a feed element in an antenna module according to an implementation of this application;

FIG. 12 is a diagram of a feed element in an antenna module according to an implementation of this application;

FIG. 13 is a diagram of a feed element in an antenna module according to an implementation of this application;

FIG. 14 is a diagram of a feed element in an antenna module according to an implementation of this application;

FIG. 15 is a diagram of a feed element in an antenna module according to an implementation of this application;

FIG. 16 is a diagram of a feed element in an antenna module according to an implementation of this application;

FIG. 17 is a diagram of a feed element in an antenna module according to an implementation of this application;

FIG. 18 is a cross-sectional diagram of an antenna module in an exploded state according to an implementation of this application;

FIG. 19 is a cross-sectional diagram of an antenna module in an assembled state according to the implementation shown in FIG. 18;

FIG. 20 is a cross-sectional diagram of an antenna module in an exploded state according to an implementation of this application;

FIG. 21 is a cross-sectional diagram of an antenna module in an assembled state according to the implementation shown in FIG. 20;

FIG. 22 is a three-dimensional exploded diagram of an antenna module according to an implementation of this application; and

FIG. 23 is a diagram of marked dimensions of the antenna module according to the implementation shown in FIG. 22.

### DESCRIPTION OF EMBODIMENTS

Terms in this application are explained as follows.

A wireless AP, namely, an access point, is a wireless access point. Simply speaking, the wireless AP is a wireless switch in a wireless network. The wireless AP is an access point for a mobile terminal user to access a wired network, and has been widely used for network coverage in various scenarios, including enterprise-level scenarios such as education and health care. The wireless AP may be used for home broadband, internal network deployment of an enterprise, and the like, and a wireless coverage range is tens of meters to hundreds of meters. Generally, the wireless AP further has an access point client mode. To be specific, a wireless link may be established between APs, to expand coverage of the wireless network.

In a MIMO, namely, multiple-input multiple-output, technology, a plurality of transmit and receive antennas are used at a transmit end and a receive end, to send and receive signals through the plurality of antennas at the transmit end and the receive end, thereby improving communication quality. This can make full use of space resources and implement multiple-input and multiple-output through the plurality of antennas, and can multiply a channel capacity of a system without an increase in spectrum resources and antenna transmit power. The technology has an obvious advantage, and therefore is considered as a core technology of next-generation communication.

The following describes embodiments of the present invention with reference to the accompanying drawings in embodiments of the present invention.

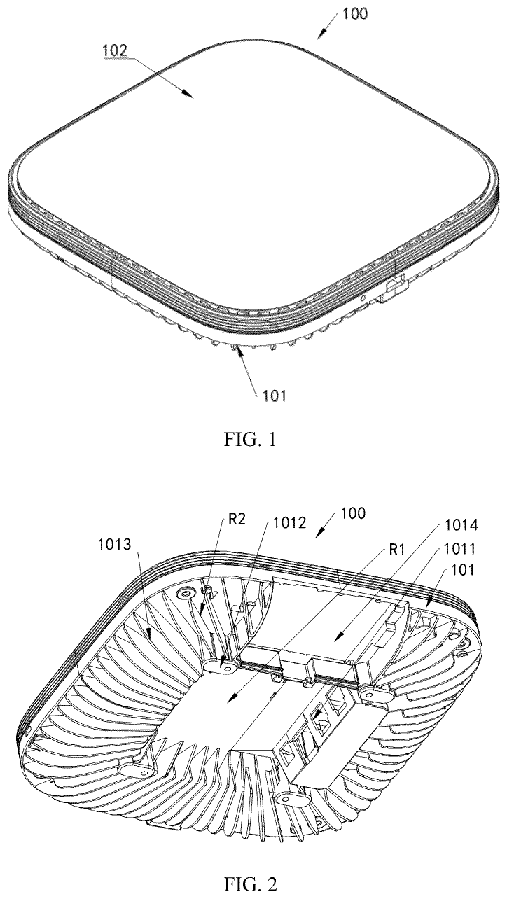

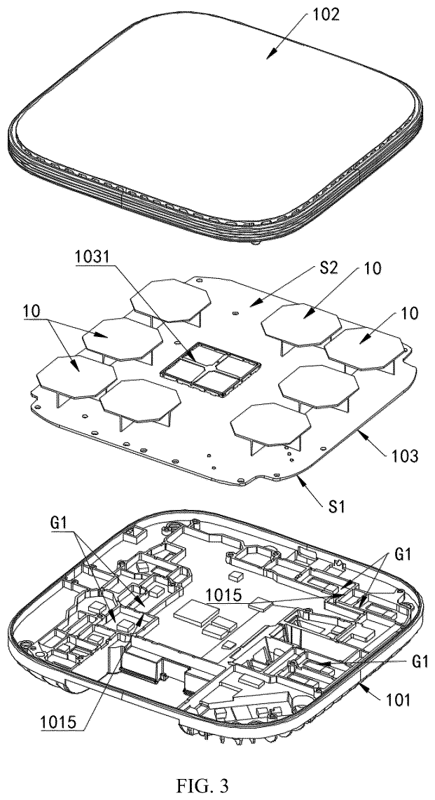

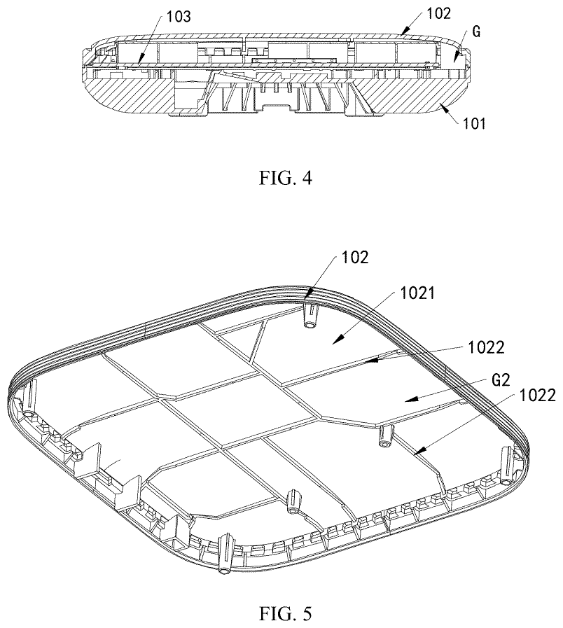

FIG. 1 and FIG. 2 each are an assembly diagram of a communication device according to an implementation of this application. FIG. 3 is a three-dimensional exploded diagram of a communication device according to an implementation of this application. FIG. 4 is a cross-sectional diagram of a communication device according to an implementation of this application. FIG. 5 is a diagram of an inner side of a second housing 102 of a communication device according to an implementation of this application.

Refer to FIG. 1, FIG. 2, FIG. 3, and FIG. 4. In an implementation, the communication device 100 is a wireless AP. The communication device 100 includes a first housing 101 and a second housing 102. The first housing 101 and the second housing 102 are fastened to each other and jointly enclosed to form an internal space G of the communication device 100. In an application environment of the communication device 100, the first housing 101 is a bottom housing, and the second housing 102 is a top housing. The first housing 101 is connected to a bearing material. For example, the first housing 101 is in contact with a desktop, a wall, or a support surface of another carrier. A periphery of the second housing 102 is usually provided without a shielding object, and is exposed to air. In an implementation, the first housing 101 is a housing having a conductor material and a shielding function (for example, a metal housing).

Refer to FIG. 2. On an outer surface of the first housing 101, the first housing 101 includes a middle region R1 and an edge region R2 surrounding a periphery of the middle region. The middle region R1 is configured to accommodate a connector socket 1011 (for example, a socket corresponding to a network port or a socket corresponding to an optical fiber port) and accommodate an external cable. A bottom block 1012 is disposed at an intersection of the middle region RI and the edge region R2. Specifically, the middle region R1 is square, and there are four bottom blocks 1012 that are distributed in four corners of the middle region R1. A heat sink 1013 is disposed in the edge region R2. The heat sink 1013 is configured to dissipate heat for a heat generating element in the communication device. The heat sink 1013 is disposed around a periphery of the connector socket 1011, and the heat sink 1013 includes a plurality of fins. Each fin extends from a junction between the edge region R2 and the middle region R1 to an outer edge of the edge region R2. The edge region R2 is further provided with an opening 1014. The opening 1014 connects the internal space G of the communication device 100 to the outside. The opening 1014 is disposed to mount an Internet of things (IoT) card module. An IoT card may be understood as an Internet of Things card, namely, a chip for network access of a device.

Refer to FIG. 3. In a specific implementation, a plurality of accommodation spaces G1 are formed on an inner surface of the first housing 101. Adjacent accommodation spaces G1 are partitioned from each other through a lower partition plate 1015. The plurality of accommodation spaces G1 are disposed independently. The plurality of accommodation spaces G1 are configured to accommodate electronic components of the communication device 100. The accommodation spaces G1 are independent of each other, so that the first housing 101 forms a shielding cover structure for the electronic components. Therefore, the first housing 101 of the communication device 100 provided in this application integrates functions of a housing and a shielding cover. The first housing 101 is combined with a mainboard 103 of the communication device 100. In this way, the first housing 101 forms a plurality of shielding covers disposed on the mainboard 103, to shield different electronic components on the mainboard 103. Therefore, in this application, there is no need to additionally dispose a shielding cover structure between the housing and the mainboard of the communication device 100. This facilitates a thin design of the communication device. The second housing 102 is made of a non-conducting material (for example, plastic). An antenna module is disposed on an inner side of the second housing 102. The second housing 102 is designed as the non-conducting material. This does not affect radiation efficiency of an antenna.

Refer to FIG. 3 and FIG. 4. The mainboard 103 is disposed inside the communication device 100. The mainboard 103 is fastened to the internal space G enclosed by the first housing 101 and the second housing 102. The mainboard 103 includes a bottom surface S1 and a top surface S2. The bottom surface S1 faces the inner surface of the first housing 101, and the top surface S2 faces an inner surface of the second housing 102. The electronic components on the mainboard 103 include a CPU, a CPU peripheral circuit, a plurality of radio frequency chips, a baseband chip, the antenna module, and other functional modules (such as a power supply module, a Bluetooth module, a network port, and an optical fiber port). On the mainboard 103, a main heat generating component and a component that needs electromagnetic shielding are disposed on the bottom surface S1, and the electronic component that needs electromagnetic shielding is correspondingly disposed in the accommodating space G1 that has a function similar to that of a shielding cover and that is formed by the first housing 101. The main heat generating component dissipates heat through the first housing 101. For example, electronic components such as the CPU, the baseband chip, the radio frequency chip, the power supply module, the Bluetooth module, the network port, the optical fiber port, and an IoT card module are disposed on the bottom surface S1 of the mainboard 103. The antenna module 10 is disposed on the top surface S2 of the mainboard 103. Because the second housing 102 is made of the non-conducting material, a side that is of the antenna module 10 and that is away from the mainboard 103 is a clearance space. This helps ensure antenna performance. The antenna module 10 is disposed in an edge region of the mainboard 103, and a middle region enclosed by the antenna module 10 is configured to accommodate the CPU peripheral circuit.

Refer to FIG. 5. In an implementation, the second housing 102 includes a plate body 1021 and an upper partition plate 1022 that protrudes from an inner surface of the plate body 1021. The upper partition plate 1022 and the plate body 1021 may be an integrated structure. In one aspect, the upper partition plate 1022 is configured to improve strength of the plate body 1021 and ensure flatness of the plate body 1021. In another aspect, the upper partition plate 1022 encloses a plurality of partitioned spaces G2 on the inner surface of the plate body 1021. In an assembled state, antenna elements of the antenna module 10 are disposed corresponding to different partitioned spaces G2. In a direction perpendicular to the mainboard 103, orthographic projections of the antenna elements of the antenna module 10 on the second housing 102 are separately located in the partitioned spaces G2.

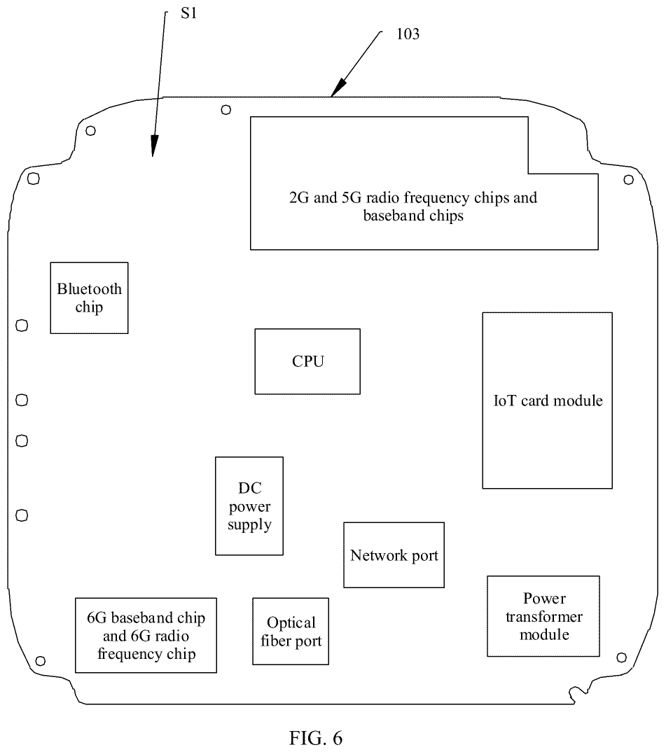

Refer to FIG. 6. In an implementation, a CPU located in the middle region is disposed on the bottom surface S1 of the mainboard 103. 2G and 5G radio frequency chips and baseband chips are disposed on the top of the CPU. The radio frequency chip and the baseband chip may be chips independent of each other. A plurality of 2G radio frequency antennas and a plurality of 5G radio frequency chips may be disposed based on an antenna arrangement requirement. Similarly, a plurality of baseband antennas may also be disposed based on an antenna frequency and an arrangement requirement. A Bluetooth chip is disposed on the left of the CPU. The IOT card module is disposed on the right of the CPU. A 6G baseband chip, a 6G radio frequency chip, the network port, the optical fiber port, a DC power supply, and a power transformer module are disposed under the CPU. The radio frequency chip and the baseband chip in the 6G baseband chip and the 6G radio frequency chip may be chips independent of each other. For the radio frequency chip, a plurality of 6G radio frequency antennas may be disposed based on an antenna arrangement requirement. Similarly, a plurality of baseband antennas may also be disposed based on an antenna frequency and an arrangement requirement. Other electronic components, for example, other processors such as a CPLD logic chip or a PHY chip, may be further disposed in the communication device provided in this application.

As shown in FIG. 3, in this application, the antenna module 10 is directly disposed on the top surface S2 of the mainboard 103, and feeder cables of the antennas in the antenna module 10 are directly arranged in the mainboard 103 (for example, microstrips on the mainboard 103 form a feed system), and no additional feeder cable is required. It is assumed that the antenna module 10 is independently fastened to an antenna board. For example, generally, the antenna board may be a metal board and is stacked with the mainboard. The radio frequency chip feeds power to the antenna module through the feeder cable. In this architecture, not only the antenna board occupies a space of the communication device, but also the feeder cable needs to occupy the space of the communication device. In addition, assembly of the antenna board and assembly of the feeder cable complicate an internal structure of the communication device. For a signal of the antenna module, quality of the signal for feeding through the feeder cable is lower than quality of the signal for direct feeding through a cable that is in the mainboard 103 and that is used as a feed structure in this application.

The antenna module 10 provided in this application is a MIMO antenna system. The antenna module 10 includes a plurality of groups of antennas (a plurality of antenna elements). The groups of antennas have different operating frequencies. In general, the antenna module may include two or more antennas working at a first frequency, and two or more antennas working at a second frequency. For example, in an implementation, the antenna module includes three groups of antennas. A first group is first-frequency antennas (for example, a 2.4 G antenna whose operating band is 2.4 GHz to 2.5 GHz), a second group is second-frequency antennas (for example, a 5 G antenna whose operating band is 5.15 GHz to 5.85 GHz), and a third group is third-frequency-band antennas (for example, a 6 G antenna whose operating band is 5.925 GHz to 7.125 GHz). Each group of antennas includes a plurality of independent antennas. The independent antenna means that the antenna has an independent feed power supply and an independent radiator, and can independently perform an antenna function. In a specific implementation, the antenna module includes four 2.4 G antennas, four 5 G antennas, and four 6 G antennas. One antenna element may be provided with one antenna of one frequency (for example, one antenna element includes only one 6 G antenna), or one antenna element may be provided with two antennas of different frequencies. For example, one antenna element includes one 2.4 G antenna and one 5 G antenna.

To ensure working efficiency of all antennas, isolation between an antenna and another antenna needs to be ensured when the antennas are working. Isolation between ports is used to quantify impact between the antennas. Higher isolation between ports indicates smaller impact between two antennas. Generally, a longer distance between antennas indicates better isolation. However, the longer distance between antennas affects a miniaturization design of the communication device. Therefore, a distance between the antennas needs to be shortened, to reduce board space occupied and obtain a communication device of a small size. For low-frequency antennas, a safe distance between two adjacent low-frequency antennas is long. Generally, a plurality of low-frequency antennas are distributed in different corners of a circuit board, to implement isolation between the antennas. However, this is not conducive to a layout of the circuit board. In addition, radio frequency chips connected to the antennas also need to be dispersedly arranged to achieve better antenna performance. If the radio frequency chips are centrally arranged and the antennas are dispersedly arranged, some antennas are definitely connected to the radio frequency chips through long cables, resulting in a loss of a radio frequency signal.

Refer to FIG. 3. In this application, the antenna module 10 is disposed on the top surface S2 of the mainboard 103, and the antenna module 10 includes a plurality of antenna elements. In a specific implementation, the antenna module 10 includes eight antenna elements. Four of the antenna elements integrate antennas at a first frequency and a second frequency. For example, there are four 2.4 G antennas and four 5 G antennas. In other words, each antenna element includes one antenna at the first frequency and one antenna at the second frequency (which may be understood as follows: One 2.4 G antenna and one 5 G antenna are disposed on one antenna support, and are disposed corresponding to a same position on the mainboard 103). Specifically, in this implementation, the four 2.4 G antennas are disposed adjacent to one another, and all the 2.4 G antennas are disposed on a same side of the central region of the mainboard 103, and corresponding positions of the four 2.4 G antennas and the four 5 G antennas on the mainboard 103 are the same. It may be understood that the first frequency is a low frequency, and the second frequency is a high frequency. When antenna performance and isolation are satisfied, a board space occupied by the high-frequency antenna is smaller than a board space occupied by the low-frequency antenna. In this application, the antenna at the second frequency is used as a reference orientation position for an arrangement. When the plurality of antennas at the second frequency are arranged at proper positions, an antenna at the first frequency is disposed at a position of a corresponding antenna at the second frequency, and then isolation and performance of the antennas at the first frequency are adjusted by using a decoupling technology. Such a design can reduce the board space occupied by the antenna module, and is conducive to a small-sized, light, and thin design of the communication device. Specifically, in this application, specific positions of the four 5 G antennas on the mainboard 103 are first set, then the four 2.4 G antennas are disposed on a feed circuit board of the four 5 G antennas, and then a decoupling structure is disposed for the 2.4 G antennas. This ensures isolation between adjacent 2.4 G antennas, and also ensures radiation efficiency of each 2.4 G antenna.

As shown in FIG. 3 and FIG. 4, there is no feeder cable used to feed power to the antenna module 10 inside the communication device 100. The internal structure of the communication device 100 is simple, which improves efficiency of an assembly process, reduces assembly costs, and facilitates maintenance of the communication device 100. Implementations of this application provide a cable-free feeding antenna module 10. The antenna module 10 is connected to the top surface S2 of the mainboard 103.

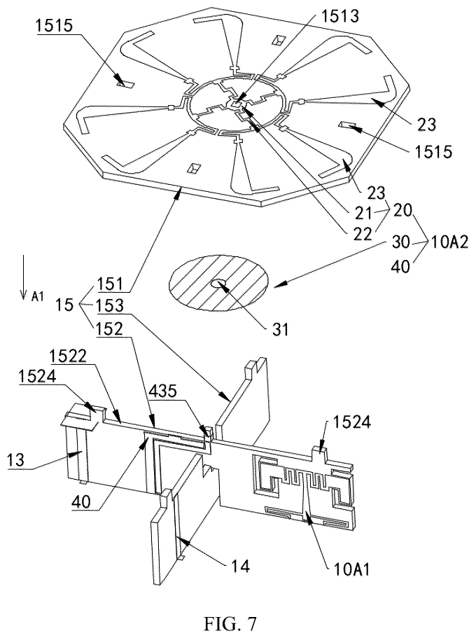

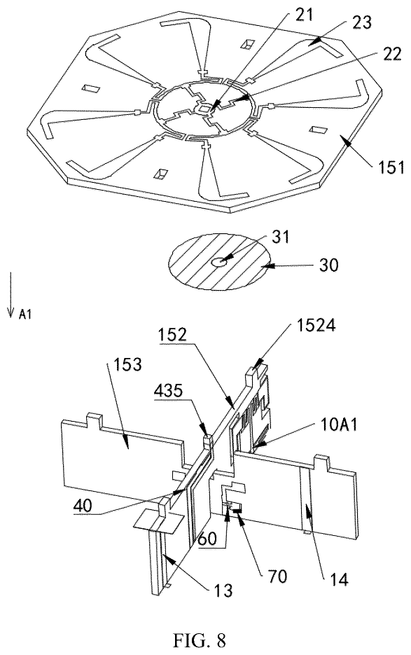

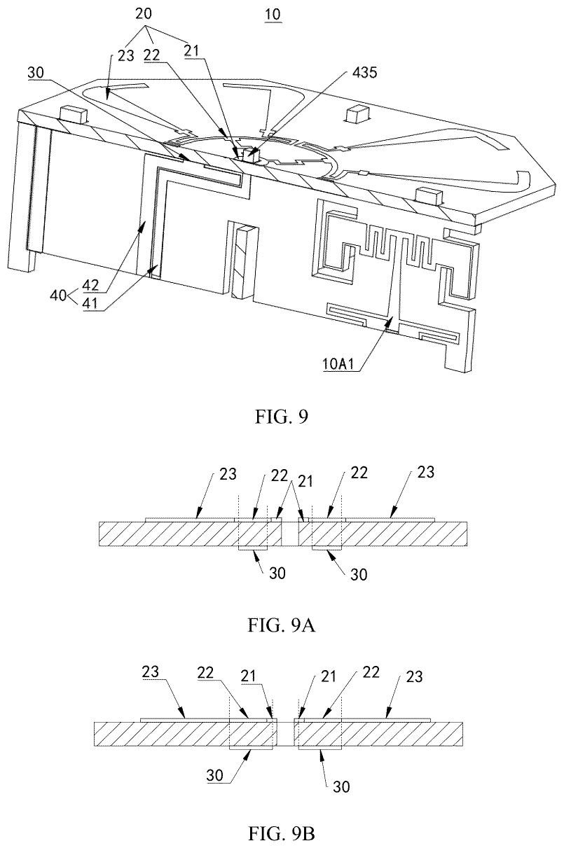

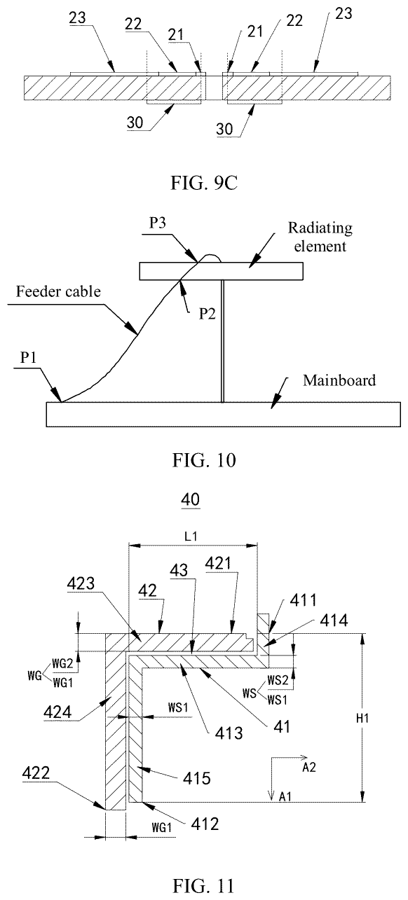

FIG. 7 is a three-dimensional exploded diagram of an antenna module 10 in a direction according to an implementation of this application. FIG. 8 is a three-dimensional exploded diagram of the antenna module 10 shown in FIG. 7 in another direction. FIG. 9 is a cross-sectional diagram of the antenna module 10 shown in FIG. 7. Refer to FIG. 7, FIG. 8, and FIG. 9. The antenna module 10 includes a radiating element 20, a ground element 30, and a feed element 40. The radiating element 20 and the ground element 30 are stacked. The ground element 30 is disposed between a mainboard 103 and the radiating element 20 in a stacked manner. The ground element 30 and the mainboard 103 are opposite to each other in a non-contact manner. A direction in which the radiating element 20 and the ground element 30 are stacked is a first direction A1. In the first direction A1, the feed element 40 is located on a side that is of the radiating element 20 and that is away from the ground element 30. The first direction A1 may be perpendicular to a direction of the mainboard 103. The radiating element 20, the ground element 30, and the feed element 40 are all metal transmission line structures or metal patch structures. In a specific implementation of this application, the radiating element 20, the ground element 30, and the feed element 40 are disposed on an insulation support, and the insulation support is assembled onto the mainboard. The insulation support may be a circuit board composition or a structure of another form.

The following first describes specific structures and a position relationship of the radiating element 20, the ground element 30, and the feed element 40.

Refer to FIG. 7, FIG. 8, and FIG. 9. The radiating element 20 is located on the top of the antenna module 10, which may be understood as a position at which the antenna module 10 is away from the mainboard 103. The radiating element 20 is adjacent to a second housing 102. The radiating element 20 includes an input interface 21, a power division element 22, and a plurality of radiating subelements 23. The plurality of radiating subelements 23 are arranged around the input interface 21. For example, the plurality of radiating subelements 23 are arranged in an annular region. Power division elements 22 and the radiating subelements 23 may be disposed in a one-to-one correspondence, and the power division elements 22 are separately connected between the radiating subelements 23 and the input interface 21. The power division element 22 and the radiating subelements 23 may alternatively be disposed in a one-to-many correspondence. For example, in the implementation shown in FIG. 7, one power division element 22 is correspondingly connected to two radiating subelements 23. The radiating element 20 includes four power division elements 22 and eight radiating subelements 23. The input interface 21 is a feeding position of the radiating element 20, the input interface 21 is configured to electrically connect to the feed element 40, and the input interface 21 is electrically connected to all the power division elements 22.

In a specific implementation, the input interface 21 is located at a central position of the radiating element 20, the power division element 22 surrounds the input interface 21, the plurality of radiating subelements 23 surround the power division element 22, and the radiating element 20 may be a rotational symmetrical structure centered on the input interface 21. A form of each radiating subelement 23 may be but is not limited to a bar shape, an arc shape, an L shape, or the like. In an implementation, an operating frequency of the radiating element 20 in a resonant state is 5 GHz, and an electrical length of each radiating subelement 23 is a quarter of an electromagnetic wave wavelength of the operating frequency of the radiating element 20. In an implementation, the power division element 22 and the plurality of radiating subelements 23 are coplanar. For example, the power division element 22 and the plurality of radiating subelements 23 are metal microstrip structures disposed at a same layer of a circuit board. In another implementation, a surface on which the power division element 22 is located is different from a surface on which the plurality of radiating subelements 23 are located. For example, the power division element 22 and the plurality of radiating subelements 23 are disposed at different layers of a circuit board. The power division element 22 may be located at an intermediate layer of the circuit board, and the plurality of radiating subelements 23 may be disposed on a surface layer of the circuit board.

The ground element 30 is a metal layer structure. For example, in an implementation, the ground element 30 is a copper foil disposed at a layer of the circuit board (which may be the intermediate layer or the surface layer of the circuit board). In another implementation, the ground element 30 may alternatively be a metal sheet structure, and the ground element 30 may be fastened to (by using an adhesive or through welding) a surface of the circuit board. In an implementation, a notch 31 is formed in a central region of the ground element 30, and a position of the notch 31 is used to accommodate a connection structure between the radiating element 20 and the feed element 40. A specific form of the ground element 30 may be a ring. An outer edge of the ground element 30 is a circle, a square, or a polygon, and an inner edge of the ground element 30 may also be a circle, a square, or a polygon.

FIG. 9A, FIG. 9B, and FIG. 9C each show a position relationship between the radiating element 20 and the ground element 30 according to a specific implementation of this application. Refer to FIG. 9A. In an implementation, the inner edge of the ground element 30 is correspondingly disposed on a periphery of the input interface 21. Specifically, a vertical projection of the inner edge of the ground element 30 on a plane on which the radiating element 20 is located is located on the periphery of the input interface 21. Refer to FIG. 9B. Alternatively, a vertical projection of the inner edge of the ground element 30 on a plane on which the radiating element 20 is located may be located inside the input interface 21. Refer to FIG. 9A, FIG. 9B, and FIG. 9C. A vertical projection of the ground element 30 on the plane on which the radiating element 20 is located coincides with at least a part of the power division element 22. As shown in FIG. 9A, the outer edge of the ground element 30 is adjacent to an inner edge of the radiating subelement 23, or the outer edge of the ground element 30 is located between an inner edge of the radiating subelement 23 and the input interface 21. Refer to FIG. 9B. The outer edge of the ground element 30 may alternatively coincide with the inner edge of the radiating subelement 23. Refer to FIG. 9C. In an implementation, a part of a projection of the ground element 30 on the plane on which the radiating element 20 is located coincides with the power division element 22, and the other part coincides with a part of the radiating subelement 23.

Refer to FIG. 7, FIG. 8, and FIG. 9. The feed element 40 is located between the ground element 30 and the mainboard 103. Specifically, the feed element 40 is a transmission line structure formed on an insulation support. In a first direction, the feed element 40 is located on a side that is of the ground element and that is away from the radiating element 20. The feed element 40 is electrically connected to a radio frequency chip on the mainboard 103, and is configured to feed power to the radiating element 20. The radio frequency chip is electrically connected to the feed element 40 through a transmission line disposed in the mainboard 103.

FIG. 10 shows a conventional solution in which a feed signal is transmitted between an antenna module and a mainboard through a radio frequency cable. Refer to FIG. 10, the antenna module is disposed above the mainboard. Power is fed to the antenna module through a feeder cable. A position at which the feeder cable is connected to a ground on the mainboard is a first connection point P1, and positions at which the feeder cable is connected to a radiating element 20 include a second connection point P2 and a third connection point P3. A specific position of the first connection point P1 on the mainboard, a specific position of the second connection point P2 on the antenna module, a specific position of the third connection point P3 on the antenna module, a length of the feeder cable between the first connection point Pl and the second connection point P2, a length of the feeder cable between the second connection point P2 and the third connection point P3, and a length of the feeder cable between the third connection point P3 and a feed point of the radiating element 20 are all important factors that affect radiation efficiency of the antenna module. In a design and assembly process, to precisely control so many important factors that affect the radiation efficiency of the antenna module, working hours are long, and professional technical support is required. Consequently, manufacturing costs of a communication device become very high. Therefore, the conventional solution in which a feed signal is transmitted through a radio frequency cable not only complicates an internal structure of the communication device, but also complicates the assembly process of the radio frequency cable. The foregoing important factors that affect the radiation efficiency of the antenna need to be considered, and it is difficult to ensure good radiation performance of the antenna. In general, a cabling path of the radio frequency cable, a length of the radio frequency cable, and the like have great impact on consistency, a board-level layout, antenna indicators, and a link insertion loss of the antenna.

The antenna module 10 provided in this application does not need to use any external radio frequency cable for feeding. The radiating element 20 is excited by using the transmission line disposed in the mainboard 103 and the feed element 40 (which is also the transmission line structure) disposed on the insulation support. This eliminates impact of a conventionally designed radio frequency cable on antenna performance. In the antenna module 10 provided in this application, carriers for transmitting an electromagnetic wave signal between the radiating element 20 and the radio frequency chip are all transmission line structures disposed in the circuit board or other insulation supports, so that the internal structure of the communication device is simple. In addition, a position and a form of the transmission line are fixed, and are designed before the antenna module 10 is assembled. Therefore, there is no adverse impact on the antenna caused in an assembly process.

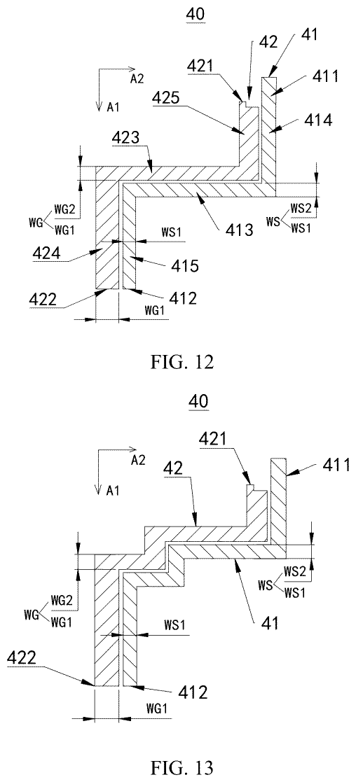

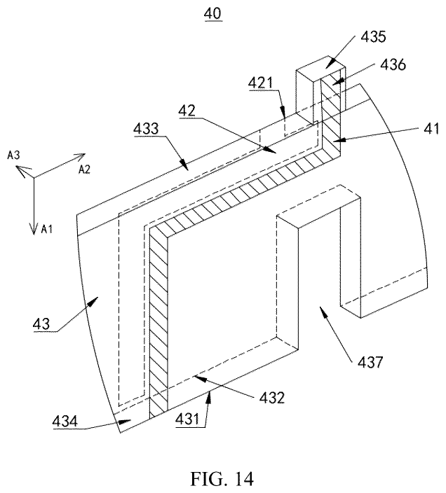

For a specific structural form of the feed element 40, refer to the implementations shown in FIG. 11, FIG. 12, FIG. 13, and FIG. 14.

Refer to FIG. 11. The feed element 40 includes a feed transmission part 41 and a ground part 42. A gap is provided between the feed transmission part 41 and the ground part 42. The feed transmission part 41 is separated from the ground part 42 by using an insulation medium 43. The insulation medium 43 between the feed transmission part 41 and the ground part 42 may be air, an insulation material of an insulation support, an insulation adhesive, or the like. A width of the feed transmission part 41 includes a first width WS, and a width of the ground part 42 includes a second width WG. The first width WS is not equal to the second width WG, to implement current balance of the antenna module 10. A design of unequal widths of the feed transmission part 41 and the ground part 42 of the feed element 40 has a decoupling function. The width of the feed transmission part 41 is a dimension of the feed transmission part 41 in a direction perpendicular to an extension path of the feed transmission part 41, and the width of the ground part 42 is a dimension of the ground part 42 in a direction perpendicular to an extension path of the ground part 42. Specifically, in an implementation, the feed transmission part 41 extends in equal widths in a first direction A1, and the feed transmission part 41 also extends in equal widths in a second direction A2; and the ground part 42 extends in equal widths in the first direction A1, and the ground part 42 also extends in equal widths in the second direction A2. As shown in FIG. 11, the first width WS includes a width WS1 of a part that is of a transmission line of the feed transmission part 41 and that extends in the first direction A1 and a width WS2 of a part that is of the transmission line of the feed transmission part 41 and that extends in the second direction A2, and the second width WG includes a width WG1 of a part that is of a transmission line of the ground part 42 and that extends in the first direction A1 and a width WG2 of a part that is of the transmission line of the ground part 42 and that extends in the second direction A2. The width WS1 of the part that is of the transmission line of the feed transmission part 41 and that extends in the first direction A1 may be equal to or different from the width WS2 of the part that is of the transmission line of the feed transmission part 41 and that extends in the second direction A2. The width WG1 of the part that is of the transmission line of the ground part 42 and that extends in the first direction A1 may be equal to or different from the width WG2 of the part that is of the transmission line of the ground part 42 and that extends in the second direction A2. In this application, that the first width WS and the second width WG are unequal means: The width WS1 of the part that is of the transmission line of the feed transmission part 41 and that extends in the first direction A1 is not equal to the width WG1 of the part that is of the transmission line of the ground part 42 and that extends in the first direction A1, and the width WS2 of the part that is of the transmission line of the feed transmission part 41 and that extends in the second direction A2 is not equal to the width WG2 of the part that is of the transmission line of the ground part 42 and that extends in the second direction A2.

In this solution, widths of the feed transmission part 41 and the ground part 42 are different (that is, the first width WS and the second width WG are unequal). This can implement current balance of the antenna module 10, and eliminate or reduce a coupling effect on the radiating element 20 generated by the feed element 40, thereby improving radiation performance of the antenna module 10. In this application, a matching problem of the antenna module 10 can be resolved by using the feed element 40 that is of the transmission line structure and that is disposed on the insulation support.

The radiating element 20 and the ground element 30 in the antenna module provided in this application form an asymmetric architecture. The asymmetric architecture means that the radiating subelement 23 of the radiating element 20 and the ground element 30 are different structures. In a resonant state, the radiating element 20 and the ground element 30 generate current imbalance. Specifically, a current on the radiating element 20 and a current on the ground element 30 have unequal amplitudes, and directions of the currents are also different. In this application, the unequal width design of the feed transmission part 41 and the ground part 42 is used, to resolve a problem of impedance mismatch caused by current imbalance generated by the radiating element 20 and the ground element 30. The unequal width design of the feed transmission part 41 and the ground part 42 achieves a current balance effect on the entire antenna module.

The feed transmission part 41 of the feed element 40 and the ground part 42 form a feed architecture of double parallel lines. The microstrip-shaped power division element 22 is combined with the feed architecture of double parallel lines of the feed element 40. If the widths of the feed transmission part 41 and the ground part 42 are equal, impedance mismatch is caused due to current imbalance. In addition, the feed element 40 and the radiating element 20 generate a mutual coupling effect, resulting in a change in an antenna pattern and affecting the radiation performance of the antenna. In this application, the feed transmission part 41 and the ground part 42 that are of unequal widths are disposed, so that the feed element 40 has a balun function and a decoupling function. This implements current balance of the antenna module 10, and improves radiation efficiency.

Refer to FIG. 11. The feed transmission part 41 includes a first feed end 411 and a second feed end 412. The first feed end 411 is electrically connected to the radiating element 20, and the second feed end 412 is configured to electrically connect to a radio frequency chip on the mainboard 103 in the communication device. The extension path of the feed transmission part 41 is a path for transmitting a radio frequency signal between the first feed end 411 and the second feed end 412, or a path on which a current flows. The ground part 42 includes a first ground end 421 and a second ground end 422. The first ground end 421 is electrically connected to the ground element 30, and the second ground end 422 is electrically connected to a ground on the mainboard 103 (namely, a grounding plane on the mainboard). The extension path of the ground part 42 is a path on which a current flows between the first ground end 421 and the second ground end 422. In the first direction, the first feed end 411 is located between the second feed end 412 and the radiating element 20, and the first ground end 421 is located between the second ground end 422 and the radiating element 20.

In an implementation, on the extension path of the feed transmission part 41, an electrical length of the feed transmission part 41 is between 0.3λ and 0.7λ. Specifically, the electrical length of the feed transmission part 41 may be 0.5λ, and λ is a wavelength of an electromagnetic wave of the radiating element 20 in the resonant state. A specific range (between 0.3λ and 0.7λ) and a specific value (0.5λ) of the electrical length of the feed transmission part 41 are limited, so that the feed transmission part 41 has the balun function, to ensure repetition continuity of impedance matching in the antenna module. The repetition continuity of impedance matching may be understood as that impedance matched at two ends of the feed transmission part 41, namely, the first feed end 411 and the second feed end 412, is the same. In this way, another matching circuit does not need to be disposed on the feed transmission part 41 to adjust matched impedance. As shown in FIG. 11, on the extension path of the feed transmission part 41, the electrical length of the feed transmission part 41 may be a sum of an electrical length H1 of the feed transmission part 41 in the first direction A1 and an electrical length L1 of the feed transmission part 41 in a second direction A2. The electrical length H1 of the feed transmission part 41 in the first direction A1 may be between 0.1λ and 0.35λ (for example, 0.25λ), and the electrical length L1 of the feed transmission part 41 in the second direction A2 may be between 0.1λ and 0.35λ (for example, 0.25λ).

In an implementation, the extension path of the feed transmission part 41 and the extension path of the ground part 42 form the architecture of double parallel lines. This may be understood as follows: A gap between the first feed end 411 of the feed transmission part 41 and the first ground end 421 of the ground part 42 is the same as a gap between the second feed end 412 of the feed transmission part 41 and the first ground end 421 of the ground part 42. In addition, on an extension path of the first feed end 411 and the ground part 42, a gap between the first feed end 411 and the ground part 42 remains unchanged, so that the feed element 40 forms the architecture of double parallel lines. In this way, the feed element 40 can form equal-amplitude reverse currents when the antenna module is in a working state, to prevent the feed element 40 from affecting resonance of the radiating element 20. This ensures that the antenna module is a vertically polarized antenna, and a good radiation pattern can be obtained. The equal-amplitude reverse currents may be understood as follows: A direction of the current on the feed transmission part 41 is opposite to a direction of the current on the ground part 42, but an amplitude of the current on the feed transmission part 41 is equal to an amplitude of the current on the ground part 42. The amplitude of the current is a largest value of an alternating current in a period.

The extension path of the feed transmission part 41 and the extension path of the ground part 42 include an extension path in the first direction A1 and an extension path in the second direction A2. The second direction A2 is perpendicular to the first direction A1. The extension path of the feed transmission part 41 in the first direction A1 may be understood as follows: In an implementation, a part of the transmission line of the feed transmission part 41 extends in the first direction A1; and in another implementation, a part of the transmission line of the feed transmission part 41 has a vertical component in the first direction A1. In other words, the part of the transmission line of the feed transmission part 41 extends obliquely relative to the first direction A1, that is, tends to extend in either the first direction A1 or the second direction A2. In an implementation of this application, the total electrical length L1 of the feed transmission part 41 in the second direction A2 is between 0.1λ and 0.35λ. In a specific implementation, the total electrical length L1 of the feed transmission part 41 in the second direction A2 is 0.25λ, and λ is a wavelength of an electromagnetic wave of the radiating element 20 in the resonant state. The electrical length of the feed transmission part 41 in the second direction A2 is limited, so that an induced current can be curbed. This can implement decoupling between the feed element 40 and the radiating element 20, and reduce coupling between the feed element 40 and the radiating element 20, thereby improving radiation efficiency of the radiating element 20.

Specific forms of the feed transmission part 41 and the ground part 42 may be a simple L-shaped transmission line architecture, or may be formed by combining a plurality of L-shaped transmission lines, or include an arc-shaped transmission line, a sawtooth transmission line, a wavy line transmission line, or the like. In an implementation, as shown in FIG. 11, some transmission lines that are of the feed transmission part 41 and that extend in the second direction A2 are collinear. This solution is a simple cabling solution for the feed transmission part 41. The electrical length of the feed transmission part 41 is easily controlled, and an effect of curbing an induced current is more obvious. In a specific implementation, the feed transmission part 41 includes a first segment 413, a second segment 414, and a third segment 415. The first segment 413 extends in the second direction A2. The second segment 414 and the third segment 415 are respectively connected to the two ends of the first segment 413, and both extend in the first direction A1. The second segment 414 is connected between the first segment 413 and the radiating element 20. The third segment 415 is connected between the first segment 413 and a transmission line that is on the mainboard 103 and that is used to connect the radio frequency chip. An electrical length of the first segment 413 is between 0.1λ and 0.35λ (for example, may be 0.25λ). A sum of an electrical length of the second segment 414 and an electrical length of the third segment 415 is between 0.1λ and 0.35λ (for example, may be 0.25λ). A sum of electrical lengths of the first segment 413, the second segment 414, and the third segment 415 is an electrical length (0.5λ) on the extension path of the feed transmission part 41. In another implementation, there may be an included angle between an extension direction of the first segment 413 and the second direction A2. For example, the first segment 413 is inclined by 15 degrees relative to the second direction A2 (this angle value is merely an example for description, and is not limited in this solution, and may also be another angle value). An electrical length of a component of the first segment 413 in the second direction A2 is 0.252. Similarly, there may also be an included angle between the second segment 414 and the first direction A1 and between the third segment 415 and the first direction A1. A sum of an electrical length of a component of the second segment 414 in the first direction A1 and an electrical length of a component of the third segment 415 in the first direction A1 is between 0.1λ and 0.35λ (which may be, for example, 0.252).

In this implementation, as shown in FIG. 11, the ground part 42 is a two-segment structure. The ground part 42 includes a fourth segment 423 and a fifth segment 424. The fourth segment 423 and the first segment 413 may extend in parallel. The fourth segment 423 and the first segment 413 may be parallel to each other. The fifth segment 424 and the third segment 415 extend in parallel. The fifth segment 424 and the third segment 415 may be parallel to each other. An electrical length of the fourth segment 423 may be between 0.1λ and 0.35λ (for example, may be 0.25λ), and an electrical length of the fifth segment 424 may be between 0.1λ and 0.35λ (for example, may be 0.25λ). The fourth segment 423 is directly connected to the ground element 30 of the antenna module 10, and may be directly connected through welding, or may be fastened by using a conductive adhesive.

In another implementation, refer to FIG. 12. A main difference between the implementation shown in FIG. 12 and the implementation shown in FIG. 11 lies in that the ground part 42 is a three-segment structure. In addition to the fourth segment 423 and the fifth segment 424, the ground part 42 further includes a sixth segment 425. The sixth segment 425 and the second segment 414 extend in parallel. An L-shaped transmission line architecture may be formed between the sixth segment 425 and the fourth segment 423. An end that is of the sixth segment 425 and that is away from the fourth segment 423 is connected to the ground element 30 of the feed element 40. Extension directions of the sixth segment 425 and the fifth segment 424 may both be the first direction A1. A sum of electrical lengths of the sixth segment 425 and the fifth segment 424 is between 0.1λ and 0.35λ (for example, may be 0.25λ). In this implementation, the fourth segment 423 is separated from the ground element 30 of the antenna module 10 by using an insulation medium.

In an implementation, as shown in the implementations in FIG. 11 and FIG. 12, the fourth segment 423 and the fifth segment 424 are perpendicular to each other, and form an L-shaped transmission line architecture, and the first segment 413 and the third segment 415 form an L-shaped transmission line architecture. The first segment 413 and the second segment 414 also form an L-shaped transmission line architecture. In another implementation, an included angle between the fourth segment 423 and the fifth segment 424 may be greater than 90 degrees or less than 90 degrees. Similarly, included angles between the first segment 413 and the third segment 415 and between the first segment 413 and the second segment 414 may also be greater than 90 degrees or less than 90 degrees.

In an implementation, refer to FIG. 13. The transmission lines that are of the feed transmission part 41 and that extend in the second direction A2 include at least two transmission line segments, and the at least two transmission line segments are parallel to each other but are not collinear. Vertical distances from segments that are of the transmission line and that extend in the second direction A2 to the ground element 30 of the antenna module 10 are different. This solution is a specific cabling solution for the feed transmission part 41. In this application, feed transmission parts 41 in different forms may be disposed based on different specific assembly environments and electromagnetic field environments of the antenna module, and a specific transmission form on an insulation setting may be adjusted to implement different designs. This is simple and easy to implement. The at least two transmission line segments are connected through a transmission line that extends in the first direction A1. In this implementation, extending in the first direction A1 and extending in the second direction A2 may be understood as follows: may coincide with the first direction A1, or may form an included angle with the first direction A1, but has a vertical component in the first direction A1; or may coincide with the second direction A2, or may also form an included angle with the second direction A2, but has a vertical component in the second direction A2. In a specific implementation, there are two transmission lines that extend in the second direction A2 in the feed transmission part 41, and the feed transmission part 41 is a five-segment structure. In other words, the feed transmission part 41 includes two transmission line segments that extend in the second direction and three transmission line segments that extend in the first direction A1. A sum of electrical lengths of the two transmission line segments that extend in the second direction A2 is between 0.1λ and 0.35λ (for example, may be 0.25λ), and a sum of electrical lengths of the three transmission line segments in the first direction A1 is between 0.1λ and 0.35λ (for example, may be 0.25λ).

In the implementations shown in FIG. 11, FIG. 12, and FIG. 13, the feed transmission part 41 and the ground part 42 may be coplanar, which means that the feed transmission part 41 and the ground part 42 are located on a same plane. In other words, planes of insulation supports bearing the feed transmission part 41 and the ground part 42 are the same. For example, when the insulation support is a circuit board structure, the feed transmission part 41 and the ground part 42 are located at a same layer of the circuit board. Thicknesses of the feed transmission part 41 and the ground part 42 are not considered in this application. The thicknesses of the feed transmission part 41 and the ground part 42 may be different. However, it may be understood that the feed transmission part 41 and the ground part 42 are coplanar, provided that the feed transmission part 41 and the ground part 42 are disposed on a same plane. Manufacturing costs of the coplanar design are low, and a position relationship between the feed transmission part and the ground part is easy to control.

If the insulation support is a structure of another type, the feed transmission part 41 and the ground part 42 are located on a same surface of the insulation support. In this implementation, from the first feed end 411 to the second feed end 412, the feed transmission part 41 extends in equal widths. From the first ground end 421 to the second ground end 422, the ground part 42 also extends in equal widths. A width of the ground part 42 is greater than a width of the feed transmission part 41.

Alternatively, the feed transmission part 41 of the feed element 40 and the ground part 42 in the implementations shown in FIG. 11, FIG. 12, and FIG. 13 may be not coplanar. For example, when the feed element 40 is disposed on a circuit board, the feed transmission part 41 and the ground part 42 may be separately located at different layers of the circuit board, but a structure and a position relationship of projections of the feed transmission part 41 and the ground part 42 on a same surface of the circuit board are architectures shown in FIG. 11, FIG. 12, and FIG. 13.

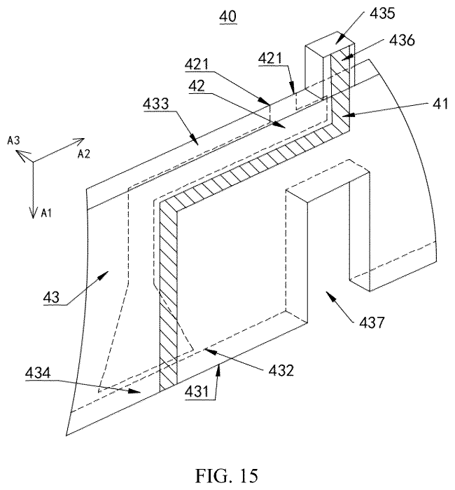

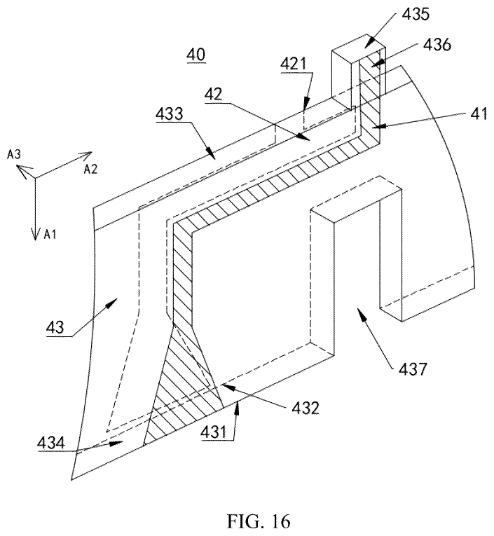

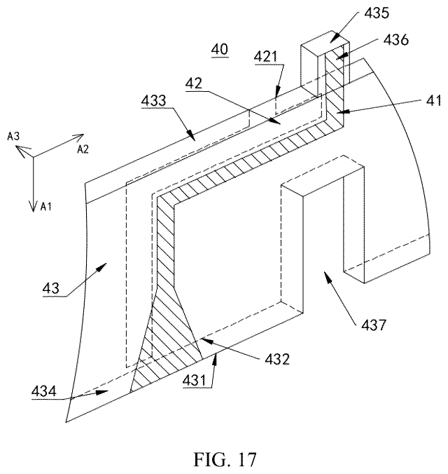

In another implementation, refer to FIG. 14, FIG. 15, FIG. 16, and FIG. 17. A plane on which the feed transmission part 41 is located and a plane on which the ground part 42 is located are not coplanar. In other words, the feed transmission part 41 and the ground part 42 form a non-coplanar transmission line architecture. In FIG. 14 and FIG. 15, the feed transmission part 41 and the ground part 42 are disposed on two surfaces of a circuit board. The feed transmission part 41 is expressed by using a solid line and an internal section line, to indicate that a surface that is of the circuit board and on which the feed transmission part 41 is located is a visible surface. The ground part 42 is expressed by using a dashed line and a blank interior (without a section line). A surface that is of the circuit board and on which the ground part 42 is located is an invisible surface. Specifically, the implementations shown in FIG. 14, FIG. 15, FIG. 16, and FIG. 17 indicate that the feed transmission part 41 and the ground part 42 are located at different layers of the circuit board 43, but projections of the feed transmission part 41 and the ground part 42 on a same surface of the circuit board 43 are at least partially overlapped. Compared with that in a coplanar design, the non-coplanar transmission architecture provided in this solution has advantages of saving a space and reducing an area occupied on the board. A thickness of a substrate of the circuit board is just used for insulation between the feed transmission part and the ground part, thereby reducing manufacturing costs. The circuit board 43 includes a first surface 431, a second surface 432, a top edge 433, and a bottom edge 434. The first surface 431 and the second surface 432 are disposed opposite to each other in a third direction A3. The feed transmission part 41 is located on the first surface 431, the ground part 42 is located on the second surface 432, and both the feed transmission part 41 and the ground part 42 extend from the bottom edge 434 to the top edge 433. The circuit board 43 includes a plug structure 435. The plug structure 435 protrudes from the top edge 433. The plug structure 435 is configured to electrically connect to the radiating element 20. Specifically, a conductive connecting part 436 is disposed on the plug structure 435, and the conductive connecting part 436 is electrically connected to the feed transmission part 41. The first ground end 421 of the ground part 42 extends to the top edge 433, and is configured to electrically connect to the ground element 30. The bottom edge 434 is provided with a clamping groove 437, and the clamping groove 437 is used for fastening to another circuit board or support. In the third direction A3 (for example, the third direction A3 may be a thickness direction of the circuit board), the feed transmission part 41 directly faces the ground part 42. The third direction A3 is perpendicular to the second direction A2, and the third direction A3 is also perpendicular to the first direction A1. Extension solutions and specific forms of the feed transmission part 41 in the first direction A1 and the second direction A2 are the same as those in the implementation shown in FIG. 11, and extension solutions and specific forms of the ground part 42 in the first direction A1 and the second direction A2 are the same as those of the feed transmission part 41. In an implementation, the feed transmission part 41 and the ground part 42 of the antenna module provided in this solution may be disposed on two surfaces (for example, a front surface and a rear surface) of the circuit board.

In the implementation shown in FIG. 14, for the feed transmission part 41, from the first feed end 411 to the second feed end 412, the feed transmission part 41 extends in equal widths. For the ground part 42, from the first ground end 421 to the second ground end 422, the ground part 42 also extends in equal widths. However, the width of the feed transmission part 41 is different from the width of the ground part 42.

In the implementation shown in FIG. 15, for the feed transmission part 41 (which has a same structural form as that of the feed transmission part 41 in the implementation shown in FIG. 14), from the first feed end 411 to the second feed end 412, the feed transmission part 41 extends in equal widths. For the ground part 42, from the first ground end 421 and the second ground end 422, a part of the ground part 42 extends in equal widths, and a part of the ground part 42 extends in unequal widths. Specifically, a part that is of the ground part 42 and that extends in the second direction extends in equal widths, an upper half of a part that is of the ground part 42 and that extends in the first direction extends in equal widths, and a lower half of the part that is of the ground part 42 and that extends in the first direction extends in unequal widths. The part that is of the ground part 42 and that extends in unequal widths is a trapezoidal structure with a narrow upper part and a wide lower part. In another implementation, the part that is of the ground part 42 and that extends in unequal widths may alternatively be disposed in another form (for example, a square or a circle), or at another position (for example, located at the part that extends in the second direction or the upper half of the part that extends in the first direction).

The feed transmission part and the ground part that extend in unequal widths may extend in gradually changed widths to facilitate impedance adjustment.

In the implementation shown in FIG. 16, for the feed transmission part 41, from the first feed end 411 to the second feed end 412, a part of the feed transmission part 41 extends in equal widths, and a part of the feed transmission part 41 extends in unequal widths. For the ground part 42, from the first ground end 421 and the second ground end 422, the ground part 42 extends in equal widths.

In the implementation shown in FIG. 17, for the feed transmission part 41, from the first feed end 411 to the second feed end 412, a part of the feed transmission part 41 extends in equal widths, and a part of the feed transmission part 41 extends in unequal widths. For the ground part 42, from the first ground end 421 and the second ground end 422, a part of the ground part 42 extends in equal widths, and a part of the ground part 42 extends in unequal widths.

Refer to FIG. 7, FIG. 8, and FIG. 9. In an implementation, the antenna module 10 includes a support 15 including a printed circuit board. The antenna module 10 is formed by the radiating element 20, the ground element 30, and the feed element 40 formed on the support 15. This has advantages such as easy manufacturing and low manufacturing costs. The support 15 includes a first plate 151, a second plate 152, and a third plate 153. The radiating element 20 and the ground element 30 are formed on the first plate 151. The second plate 152 is an insulation support for disposing the feed element 40. The second plate 152 and the third plate 153 are disposed in an intersecting manner, and both are located between the first plate 151 and the mainboard 103. A specific structure of the second plate 152 may be the same as the structure of the circuit board 43 in the implementation shown in FIG. 14.

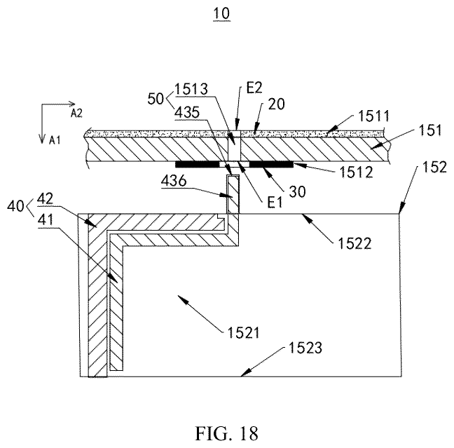

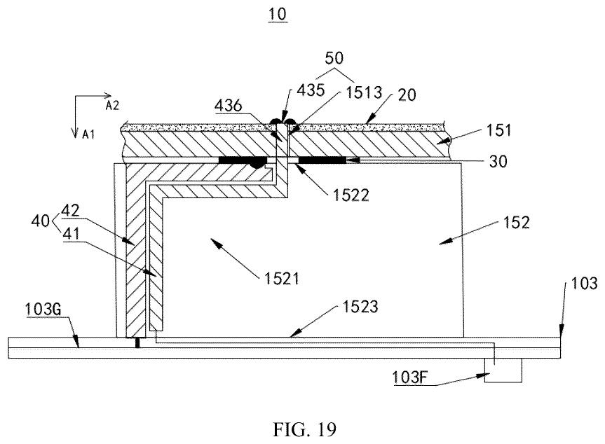

Refer to FIG. 18 and FIG. 19. The first plate 151 includes a first layer 1511 and a second layer 1512 that are stacked. In an implementation, the first layer 1511 is a top surface of the first plate 151, and the second layer 1512 is a bottom surface of the first plate 151. The radiating element 20 is located at the first layer 1511, and the ground element 30 is located at the second layer 1512. The second plate 152 includes a first edge 1522 and a second edge 1523 that are disposed opposite to each other and a cabling layer 1521. The cabling layer 1521 is located between the first edge 1522 and the second edge 1523. The second plate 152 is located on a side of the first plate 151. The first edge 1522 is connected to the first plate 151. The feed element 40 is disposed at the cabling layer 1521. An included angle is formed between the cabling layer 1521 and the first layer 1511. Specifically, the cabling layer 1521 may be perpendicular to the first layer 1511. The mainboard 103, the ground element 30, and the radiating element 20 are sequentially stacked in the first direction A1. The mainboard 103, the second plate 152, and the first plate 151 are sequentially connected in the first direction A1. The mainboard 103 and the first plate 151 may be disposed in parallel to each other. For example, the mainboard 103 and the first plate 151 are in a horizontal placement state, and the second plate 152 is in a vertical placement state. Both the first plate 151 and the second plate 152 are flat plate structures, and the second plate 152 may be vertically connected between the mainboard 103 and the first plate 151. In this solution, the antenna module 10 is provided with the first plate 151 and the second plate 152. A manufacturing process is simple, and manufacturing costs are low. In addition, the antenna module 10 has an advantage of a light weight. This facilitates a design of a slim and short communication device.

In another implementation, the radiating element 20, the ground element 30, and the feed element 40 may alternatively be disposed on an insulation support of another type, for example, on an integrated plastic support formed by injection molding. One part of the plastic support is configured to dispose the radiating element 20 and the ground element, and the other part of the plastic support is configured to dispose the feed element 40. The plastic support may be in a cylindrical shape, a square shape, or the like that is suitable for bearing the radiating element 20, the ground element, and the feed element 40.

Refer to FIG. 18 and FIG. 19. In this solution, the ground part 42 is electrically connected to the ground element 30 through a connection between the first edge 1522 and the first plate 151. Specifically, in an implementation, the first edge 1522 is in contact with the first plate 151. The ground part 42 may be electrically connected to the ground element 30 through contact between the ground part 42 at the cabling layer 1521 and the ground element 30 on the first plate 151, or the ground part 42 may be stably connected to the ground element 30 through welding. In an implementation, the ground element 30 is located on a surface of the first plate 151, and the ground part 42 is located on a surface of the second plate 152. When the first plate 151 is in contact with the second plate 152, the ground element may be fastened to the ground part 42 through welding. A black region similar to a semicircle in FIG. 19 is a welding position. The implementation shown in FIG. 19 merely schematically shows a welding relationship between the ground part 42 and the ground element 30, and does not constitute a limitation on a specific welding position or welding structure.

Refer to FIG. 18 and FIG. 19. A connection structure 50 is disposed at a joint between the first plate 151 and the second plate 152, and the connection structure 50 may be understood as a structure similar to a connector, or a structure in which a plug matches a jack. The connection structure 50 is configured to implement an electrical connection between the feed transmission part 41 and the radiating element 20. In this application, in a process of assembling and connecting the first plate 151 and the second plate 152, the electrical connection between the feed element 40 and the radiating element 20 and the electrical connection between the feed element 40 and the ground element 30 can be implemented. Such electrical connections are reliable, and a loss is low. In an implementation, in this application, an electrical connection between the feed transmission part 41 and the radiating element 20 is implemented through matching between a structure protruding from an edge of the second plate 152 and a hole structure on the first plate 151. Specifically, the first plate 151 is provided with a hole 1513 that penetrates the first layer 1511 and the second layer 1512. The second plate 152 includes a plug structure 435 protruding from the first edge 1522. At least a part of the plug structure 435 is located in the hole 1513. The connection structure 50 includes the hole 1513 and the plug structure 435, and the connection structure 50 further includes a conductive connecting part 436. As shown in FIG. 19, the conductive connecting part 436 is electrically connected between the radiating element 20 and the feed transmission part 41. The conductive connecting part 436 may include a conductive layer that is electrically connected between the radiating element 20 and the feed transmission part 41, a conductive sheet, a conductive adhesive, or a solder.

As shown in FIG. 18 and FIG. 19, in an implementation, the hole 1513 on the first plate 151 is a through hole. The hole 1513 includes a first open end E1 and a second open end E2. The plug structure 435 is plugged into the hole 1513 from the first open end E1. The conductive connecting part 436 is welded onto the radiating element 20 from a side of the second open end E2. The first layer 1511 is a top surface of the first plate 151, and the second layer 1512 is a bottom surface of the first plate 151. The first open end E1 is located on the bottom surface, and the second open end E2 is located on the top surface.

As shown in FIG. 19, the second edge 1523 of the second plate 152 is connected to the mainboard 103 of the communication device. A grounding plane 103G is disposed inside the mainboard 103, and a radio frequency chip 103F is further disposed on the mainboard 103. The feed transmission part 41 of the feed element 40 is electrically connected to the radio frequency chip 103F through a transmission line in the mainboard 103, and the ground part 42 of the feed element 40 is electrically connected to the grounding plane 103G in the mainboard 103. FIG. 19 schematically shows a manner of a connection between the ground part 42 and the grounding plane 103G on the mainboard 103 and a manner of a connection between the feed transmission part 41 and the radio frequency chip 103F through a transmission line. A specific position of the grounding plane 103G, a specific position of the radio frequency chip 103F, and a specific form of the transmission line are not limited. It may be understood that the mainboard 103 is a multilayer circuit board structure. The grounding plane 103G may be one of the layers, the transmission line may be located at one of the layers, and the radio frequency chip 103F may be disposed on a surface of the mainboard 103. In an implementation, the radio frequency chip 103F is disposed on a surface that is of the mainboard 103 and that is away from the antenna module 10, and an electromagnetic shielding space (as shown in FIG. 3) is formed by a structure of the first housing 101 and the mainboard 103 of the communication device 100.

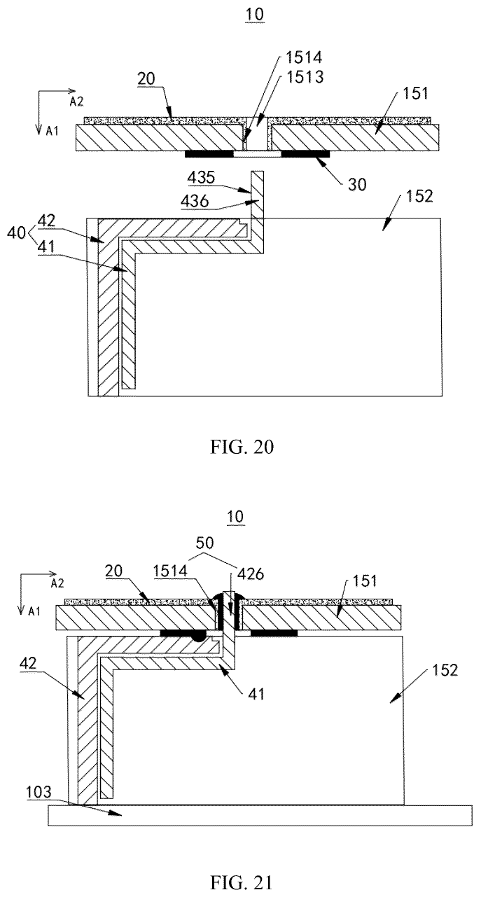

Refer to FIG. 20 and FIG. 21. A difference between the implementations shown in FIG. 20 and FIG. 21 and the implementations shown in FIG. 18 and FIG. 19 lies in that an inner wall of the hole 1513 on the first plate 151 in the implementations shown in FIG. 18 and FIG. 19 is made of an insulation material of the first plate 151. In other words, the inner wall of the hole 1513 has no conductive structure. The conductive connecting part 436 is welded onto the radiating element 20 from the second open end E2. A conductive layer 1514 is disposed on an inner wall of the hole 1513 of the first plate 151 in the implementations shown in FIG. 20 and FIG. 21, and the conductive layer 1514 is electrically connected to the radiating element 20. The plug structure 435 is plugged into the hole 1513 of the first plate 151, and an electrical connection between the conductive connecting part 436 and the conductive layer 1514 may be implemented inside the hole 1513 by using a conductive adhesive or solder. In this solution, strength and stability of the electrical connection of the connection structure 50 between the feed transmission part 41 and the radiating element 20 are better.

Refer to FIG. 7, FIG. 8, and FIG. 9. In addition to the plug structure 435 for the connection between the first edge 1522 of the second plate 152 and the first plate 151, the second plate 152 further includes a positioning rod 1524 protruding from the first edge 1522. In an implementation, there are two positioning rods 1524, and the positioning rods 1524 are symmetrically distributed on two sides of the plug structure 435. Correspondingly, the first plate 151 is provided with positioning holes 1515 disposed in a one-to-one correspondence with the positioning rods 1524. Specifically, there are two positioning holes 1515, and the positioning holes 1515 are symmetrically distributed on two sides of the hole 1513. The positioning rods 1524 are respectively plugged into the positioning holes 1515, to implement fastening of the first plate 151 to the second plate 152. The third plate 153 is also fastened to the first plate 151 through matching between the positioning rods and the positioning holes.

In a specific implementation, refer to FIG. 8. The antenna module further includes a reflecting element 60 and a lumped element 70. The lumped element 70 is loaded on the reflecting element 60, and whether the reflecting element 60 works is controlled by controlling the lumped element 70. Switching between a high-density state and an isotropic state of the antenna module is implemented through work of the reflecting element 60.

In a specific implementation, a first primary antenna 10A1 is disposed on the second plate 152. The radiating element 20, the ground element 30, and the feed element 40 form a second primary antenna 10A2. A resonance frequency of the first primary antenna 10A1 is a first frequency, and a resonance frequency of the second primary antenna 10A2 is a second frequency. The second frequency is higher than the first frequency. The first frequency is 2.4 GHz, and the second frequency is 5 GHz. The antenna module 10 includes a plurality of antenna elements 10A. Each antenna element 10A includes one first primary antenna 10A1 and one second primary antenna 10A2.

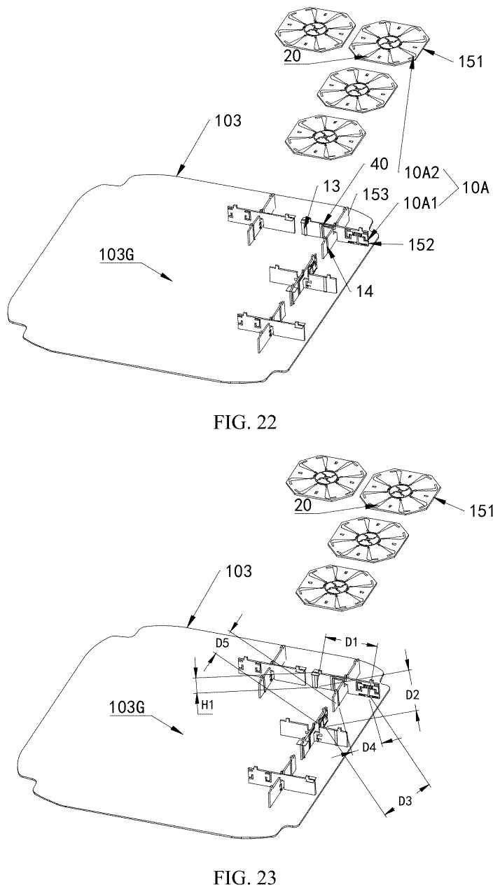

With reference to FIG. 22 and FIG. 23, FIG. 23 is a diagram of a marked distance and a marked height of the antenna module according to the implementation shown in FIG. 22. A distance D3 between the first primary antenna 10A1 and a first primary antenna 10A1 of an adjacent antenna element 10A is between 0.2 times the wavelength and 0.8 times the wavelength.

The antenna element 10A further includes a first decoupling structure 13 and a second decoupling structure 14. The first decoupling structure 13 is located on the second plate 152, and the second decoupling structure 14 is located on the third plate 153. Ends that are of the second plate 152 and the third plate 153 and that are away from the first plate 151 are connected to the mainboard 103 of the communication device. In a direction perpendicular to the grounding plane of the mainboard 103 of the communication device, a longest distance between the first decoupling structure 13 and the grounding plane 103G of the mainboard 103 is a section height Hl of the first decoupling structure 13. The section height H1 of the first decoupling structure 13 is between 0.01 times the wavelength and 0.16 times the wavelength. A distance between the first decoupling structure 13 and the first primary antenna 10A1 is a first distance D1. A distance between the first decoupling structure 13 and the first primary antenna 10A1 of the adjacent antenna element 10A is a second distance D2. Both the first distance D1 and the second distance D2 are between 0.1 times wavelength and 0.6 times the wavelength.

The first distance D1 is a distance between a phase center of the first decoupling structure 13 and a phase center of the first primary antenna 10A1. The second distance D2 is a distance between the phase center of the first decoupling structure 13 and a phase center of the first primary antenna 10A1 of the adjacent antenna element 10A. In this application, the first decoupling structure 13 is disposed to implement a small dimension of the entire antenna module. This facilitates a thin design of the communication device, and can further resolve a problem of isolation between first primary antennas 10A1 of adjacent antenna elements. The section height of the first decoupling structure 13, the distance between the first decoupling structure 13 and the first primary antenna 10A1, and the distance between the first decoupling structure 13 and the first primary antenna 10A1 of the adjacent antenna element may be controlled, to improve isolation between the adjacent first primary antennas 10A1 in a limited space and reduce impact on radiation efficiency of the first primary antennas 10A1. There is no obvious dent in a simulation diagram of the radiation efficiency of the adjacent first primary antennas 10A1.

In the antenna module 10 provided in this application, the antenna elements 10A are designed to have a same architecture. In a process of assembling the plurality of antenna elements 10A to the mainboard 103, a specific structure of each antenna element 10A does not need to be considered, because structures of all the antenna elements 10A are the same. The antenna element 10A needs to be placed only based on a position of the radio frequency chip. Therefore, this implementation helps simplify an assembly process of the communication device, reduce assembly costs, and improve manufacturing efficiency.

The second decoupling structure 14 is configured to reduce an amount of coupling between the first primary antenna 10A1 and the first primary antenna 10A1 of the adjacent antenna element 10A, and a resonance frequency of the second decoupling structure 14 is higher than the first frequency or lower than the first frequency. A frequency difference between the resonance frequency of the second decoupling structure 14 and the first frequency is between 0.03 GHz and 0.33 GHz. The resonance frequency of the second decoupling structure 14 is limited to a range of (fL−0.33 GHZ) to (fL−0.03 GHz) or (fH+0.03 GHz) to (fH+0.33 GHz), so that isolation can be improved and an efficiency dent is not introduced into the band. Herein, fL to fH are a frequency range (namely, the first frequency) of the first primary antenna 10A1. For example, fL to fH are 2.4 GHz to 2.5 GHz.

Distances D4 and D5 between the second decoupling structure 14 and the first primary antennas 10A1 are between 0.05 times the wavelength and 0.6 times the wavelength. The distances D4 and D5 between the second decoupling structure 14 and the first primary antennas 10A1 may be shorter than the distance between the first decoupling structure 13 and the first primary antenna 10A1 (the first distance D1), or may be shorter than the distance between the first decoupling structure 13 and the first primary antenna 10A1 of the adjacent antenna element 10A (the second distance D2).

In this application, the resonance frequency of the second decoupling structure 14 is adjusted, so that the resonance frequency of the second decoupling structure 14 is not the same as the first frequency, but is slightly higher or lower. This implements decoupling between the first primary antennas 10A1 of the adjacent antenna elements 10A, thereby improving isolation and reducing the impact on the radiation efficiency of the antenna. Specifically, when the second decoupling structure 14 generates resonance, an efficiency dent is generated for an electromagnetic wave at a resonance frequency of the second decoupling structure 14. For the first primary antenna 10A1 of the adjacent antenna element 10A, the efficiency dent generated by the second decoupling structure 14 may avoid an in-band frequency (namely, the first frequency) of resonance of the first primary antenna 10A1 of the adjacent antenna element 10A, to reduce impact of the second decoupling structure 14 on the radiation efficiency of the first primary antenna 10A1 of the adjacent antenna element 10A.

In this application, a distance between two first primary antennas is shortened, and the first primary antenna 10A1 and the second primary antenna 10A2 are disposed on a same support, to save a space of the mainboard 103 and facilitate a small-dimension design of the antenna module. The distance between the two first primary antennas 10A1 is between 0.2 times the wavelength and 0.8 times the wavelength. If the first decoupling structure is not disposed in each antenna element, when the two first primary antennas 10A1 are in the resonant state, the two first primary antennas receive signals from each other, resulting in signal interference and poor isolation. Therefore, in this application, the distance between the two first primary antennas 10A1 is set between 0.2 times the wavelength and 0.8 times the wavelength, and the first decoupling structure 13 and the second decoupling structure 14 are disposed to ensure isolation, thereby improving efficiency of radiation between the two first primary antennas.

In this application, the first decoupling structure 13 is disposed to implement a small dimension of the antenna. This facilitates a thin design of the communication device, and can further resolve a problem of isolation between adjacent first primary antennas 10A1. The section height of the first decoupling structure 13, the distance between the first decoupling structure 13 and the first primary antenna 10A1, and the distance between the first decoupling structure 13 and the adjacent first primary antenna 10A1 may be controlled, to improve isolation between the adjacent first primary antennas 10A1 in a limited space and reduce impact on radiation efficiency of the first primary antennas 10A1. Consequently, there is no obvious dent in a simulation diagram of the radiation efficiency of the first primary antenna 10A1.

In this application, the resonance frequency of the second decoupling structure 14 is adjusted, so that the resonance frequency of the second decoupling structure is not the same as the first frequency, but is slightly higher or lower. This implements decoupling between the first primary antennas 10A1, thereby improving isolation and reducing the impact on the radiation efficiency of the antenna. Specifically, when the second decoupling structure 14 generates resonance, an efficiency dent is generated for an electromagnetic wave at a resonance frequency of the second decoupling structure 14. For the first primary antenna 10A1, the efficiency dent generated by the second decoupling structure 14 may avoid an in-band frequency (namely, the first frequency) of resonance of the first primary antenna 10A1, to reduce impact of the second decoupling structure 14 on the radiation efficiency of the first primary antenna 10A1.

Finally, it should be noted that the foregoing embodiments are merely intended for describing the technical solutions of this application, but not for limiting this application. Although this application is described in detail with reference to the foregoing embodiments, a person of ordinary skill in the art should understand that they may still make modifications to the technical solutions described in the foregoing embodiments or make equivalent replacements to some technical features thereof, without departing from the scope of the technical solutions of embodiments of this application.

1. An antenna module, comprising:
a radiating element and a ground element that are stacked; and
a feed element, wherein the feed element is a transmission line structure formed on an insulation support; in a first direction, the feed element is located on a side that is of the ground element and that is away from the radiating element; the feed element comprises a feed transmission part and a ground part; the feed transmission part is separated and insulated from the ground part; a width of the feed transmission part comprises a first width; a width of the ground part comprises a second width; the first width is not equal to the second width; the width of the feed transmission part is a dimension of the feed transmission part in a direction perpendicular to an extension path of the feed transmission part; and the width of the ground part is a dimension of the ground part in a direction perpendicular to an extension path of the ground part.

2. The antenna module according to claim 1, wherein on the extension path of the feed transmission part, an electrical length of the feed transmission part is between 0.3λ and 0.7λ, inclusively and λ is a wavelength of an electromagnetic wave of the radiating element in a resonant state.

3. The antenna module according to claim 2, wherein the extension path of the feed transmission part and the extension path of the ground part form an architecture of double parallel lines.

4. The antenna module according to claim 1, wherein a total electrical length of the feed transmission part in a second direction is between 0.15λ and 0.35λ, inclusively, λ is a wavelength of an electromagnetic wave of the radiating element in a resonant state, and the second direction is perpendicular to the first direction.

5. The antenna module according to claim 4, wherein at least two transmission lines that are of the feed transmission part and that extend in the second direction are collinear.

6. The antenna module according to claim 4, wherein at least two transmission lines that are of the feed transmission part and that extend in the second direction comprise at least two transmission line segments, and the at least two transmission line segments are connected to each other through a transmission line that extends in the first direction.

7. The antenna module according to claim 1, wherein the feed transmission part and the ground part are coplanar.

8. The antenna module according to claim 1, wherein a plane on which the feed transmission part is located and a plane on which the ground part is located are not coplanar, the feed transmission part and the ground part are disposed opposite to each other in a third direction, the third direction is perpendicular to a second direction, and the third direction is perpendicular to the first direction.

9. The antenna module according to claim 1, wherein at least one of the following is true:
the feed transmission part comprises a first feed end and a second feed end, the first feed end is electrically connected to the radiating element, and the second feed end is configured to electrically connect to a radio frequency chip on a mainboard of a communication device; and
from the first feed end to the second feed end, the feed transmission part extends in equal widths; or
the ground part comprises a first ground end and a second ground end, the first ground end is electrically connected to the ground element, and the second ground end is configured to electrically connect to a ground on the mainboard of the communication device; and from the first ground end to the second ground end, the ground part extends in equal widths.

10. The antenna module according to claim 1, wherein at least one of the following is true:
the feed transmission part comprises a first feed end and a second feed end, the first feed end is electrically connected to the radiating element, and the second feed end is configured to electrically connect to a radio frequency chip on a mainboard of a communication device; and
from the first feed end to the second feed end, a part of the feed transmission part extends in equal widths, and a part of the feed transmission part extends in unequal widths; or the ground part comprises a first ground end and a second ground end, the first ground end is electrically connected to the ground, and the second ground end is configured to electrically connect to a ground on the mainboard of the communication device; and from the first ground end to the second ground end, a part of the ground part extends in equal widths, and a part of the ground part extends in unequal widths.

11. The antenna module according to claim 1, wherein the feed transmission part comprises a first feed end and a second feed end, the first feed end is electrically connected to the radiating element, and the second feed end is configured to electrically connect to a radio frequency chip on a mainboard of a communication device; and from the first feed end to the second feed end, the feed transmission part extends in equal widths; and
the ground part comprises a first ground end and a second ground end, the first ground end is electrically connected to the ground element, and the second ground end is configured to electrically connect to a ground on the mainboard of the communication device; and from the first ground end to the second ground end, a part of the ground part extends in equal widths, and a part of the ground part extends in unequal widths.

12. The antenna module according to claim 1, wherein the ground part comprises a first ground end and a second ground end, the first ground end is electrically connected to the ground element, and the second ground end is configured to electrically connect to a ground on a mainboard of a communication device; and from the first ground end to the second ground end, the ground part extends in equal widths; and
the feed transmission part comprises a first feed end and a second feed end, the first feed end is electrically connected to the radiating element, and the second feed end is configured to electrically connect to a radio frequency chip on the mainboard of the communication device; and from the first feed end to the first feed end, a part of the feed transmission part extends in equal widths, and a part of the feed transmission part extends in unequal widths.

13. The antenna module according to claim 1, wherein the antenna module comprises a first plate and a second plate;
the first plate comprises a first layer and a second layer that are stacked, the radiating element is located at the first layer, and the ground element is located at the second layer; and
the second plate is the insulation support, the second plate comprises a first edge and a second edge that are disposed opposite to each other and a cabling layer, the cabling layer is located between the first edge and the second edge, the second plate is located on a side of the first plate, the first edge is connected to the first plate, the feed element is disposed at the cabling layer, and an included angle is formed between the cabling layer and the first layer.

14. The antenna module according to claim 13, wherein the ground part is electrically connected to the ground element through a connection between the first edge and the first plate, a connection structure is disposed at a joint between the first plate and the second plate, and the connection structure is configured to implement an electrical connection between the feed transmission part and the radiating element.

15. The antenna module according to claim 14, wherein the first plate is provided with a hole that penetrates the first layer and the second layer, the second plate comprises a plug structure protruding from the first edge, at least a part of the plug structure is located in the hole, the connection structure comprises the hole and the plug structure, the connection structure further comprises a conductive connecting part, and the conductive connecting part is electrically connected between the radiating element and the feed transmission part.

16. The antenna module according to claim 15, wherein the hole is a through hole, the hole comprises a first open end and a second open end, the plug structure is plugged into the hole from the first open end, and the conductive connecting part is welded onto the radiating element from a side of the second open end.

17. The antenna module according to claim 16, wherein the first layer is a top surface of the first plate, the second layer is a bottom surface of the first plate, the first open end is located on the bottom surface, and the second open end is located on the top surface.

18. The antenna module according to claim 13, wherein the second edge of the second plate is connected to a mainboard of a communication device, the ground part of the feed element is electrically connected to a grounding plane on the mainboard, and the feed transmission part is electrically connected to a radio frequency chip on the mainboard through a transmission line disposed on the mainboard.

19. The antenna module according to of claim 13, wherein a first primary antenna is disposed on the second plate, the radiating element, the ground element, and the feed element form a second primary antenna, a resonance frequency of the first primary antenna is a first frequency, a resonance frequency of the second primary antenna is a second frequency, and the second frequency is higher than the first frequency.

20. A communication device, comprising a radio frequency chip and an antenna module, wherein the antenna module is electrically connected to the radio frequency chip; and the antenna module comprises:
a radiating element and a ground element that are stacked; and
a feed element, wherein the feed element is a transmission line structure formed on an insulation support; in a first direction, the feed element is located on a side that is of the ground element and that is away from the radiating element; the feed element comprises a feed transmission part and a ground part; the feed transmission part is separated and insulated from the ground part; a width of the feed transmission part comprises a first width; a width of the ground part comprises a second width; the first width is not equal to the second width; the width of the feed transmission part is a dimension of the feed transmission part in a direction perpendicular to an extension path of the feed transmission part; and the width of the ground part is a dimension of the ground part in a direction perpendicular to an extension path of the ground part.
